(19) United States
(12) Patent Application Publication
(10) Pub. No.: US 2004/0054056 A1
(43) Pub. Date: Mar. 18, 2004

(54) Additives for use in polymer processing and methods of preparation and use thereof

(76) Inventors: John D. Barber, Newport Beach, CA (US); Gerald F. Brem, Chino Hills, CA (US); Jess Rae Booth, Newport Beach, CA (US)

Correspondence Address: FULBRIGHT & JAWORSKI L.L.P., John D. McConaghy, 865 South Figueroa, Twenty-Ninth Floor, Los Angeles, CA, 90017-2571, US

(21) Appl. No.: 10/643,528

(22) Filed: Aug. 19, 2003

Related U.S. Application Data
(60) Provisional application No. 60/404,656, filed on Aug. 19, 2002.
(60) Provisional application No. 60/454,528, filed on Mar. 13, 2003.

(51) Int. Cl. C08K 3/26; C08K 3/34

(52) U.S. Cl. 524/425; 524/442

(57) ABSTRACT

Compositions comprising a polymeric liquid and a viscosity modifier comprising a solid material active in lowering the viscosity of the polymeric liquid. The solid material has a particle size of about 75 microns equivalent spherical diameter and is present at a concentration of up to about 2% by weight of the composition. The solid material can act by lowering the viscosity of the polymeric liquid at stress amplitudes and strain rates where a linear relation exists between stress amplitude and strain rate, and by lowering the viscosity of the polymeric liquid at stress amplitudes and strain rates approaching and exceeding the critical stress value of the polymeric liquid. Methods of preparing and using the compositions, and methods of selecting the solid material, are presented.

### CROSS-REFERENCE TO RELATED APPLICATIONS

This application claims the benefit of U.S. provisional application Serial No. 60/404,656 filed on Aug. 19, 2002, and U.S. provisional application Serial No. 60/454,528, filed on Mar. 13, 2003.

### BACKGROUND OF THE INVENTION

The field of the invention is additives and processes used in polymer processing.

The polymer industry is traditionally divided into thermoplastics, i.e., polymers that melt at elevated temperatures and result in finished articles upon cooling, and thermosets that are monomers or partially polymerized liquids that are finished by chemical, thermal, or radiation induced polymerization. Newer classes of polymers, thermoplastic vulcanizates, combine processing characteristics of thermoplastics and thermosets. For example, reaction injection molding is a process whereby a viscous partially polymerized compound is injection molded much like a typical thermoplastic polymer but is cured as a result of chemical or thermal reaction. It is a likely precursor to many new techniques that will further blur division of thermoplastic polymers and partially polymerized liquids that are polymerized by chemical reaction. For purposes here, there is little difference in this continuum. As such, the term polymeric liquid is used here to refer to any type of precursor to a finished article composed of a polymer. The precursor may be polymerized, partially polymerized or unpolymerized. The commonality is that at the end of processing the article is composed of a polymer.

Polymeric liquids as used herein are further defined as including, but are not limited to, monomers, oligamers, homopolymers, copolymers, mixtures of polymers, chemically and/or mechanically modified polymers, or polymers filled with natural or synthesized materials including polymer-non-polymer composites, polymer-organometallic composites, polymer-metallic composites and nanocomposite materials. The polymeric liquids, when made into a finished article, will be referred to as a polymer; however, mixtures are referred to as polymer-solid formulations or systems regardless of physical state (solid/liquid).

A solid material is defined as being a natural or manufactured material with a crystalline structure, amorphous structure, or a combination of both crystalline and amorphous phases, where the solid material has sufficiently high viscosity such that it readily holds its shape at temperatures and pressures typically present during processing of polymers.

Polymeric liquids have moderate to high viscosities. As a consequence, the polymeric liquids are difficult to move or form into complex shapes. Yet, the usefulness of goods composed of polymers, particularly the inherent characteristics of relatively light weight, high strength, recyclability, chemical resistance and low material cost, has created an immense demand for such goods.

In order to remain competitive and profitable on a worldwide basis, the polymer industry continually seeks ways to optimize the processing or molding of polymeric liquids and has been compelled to push the limits of equipment, materials and process parameters. Molding as used here is the process of forming a polymeric liquid into a finished shape and can include but is not limited to injection, reaction-injection, extrusion, blow, compression, thermoforming, casting, other methods, or combination of methods for molding. Often times, an “improvement” or “new advance” in the industry represents only a partial solution to the overall polymeric liquid-processing problem. A particular “solution” to a polymeric liquid-processing problem typically improves only one part of the process, while at the same time creates new problems in other parts of the total process or in attributes of the finished articles.

Polymer processing can usually be improved by decreasing the viscosity of the polymeric liquid to be molded. Attempts in the art to decrease the viscosity of a polymeric liquid and to gain processing advantages often result in adverse “side effects.

Many in the art have attempted to optimize the molding of polymeric liquids by increasing the press size. Because larger presses exert greater forces, said presses are able to form even the most viscous polymeric liquids or increase the production rate of most polymeric liquids regardless of their viscosity. However, large presses are not the “single solution” to finishing problems facing the industry. Small goods, goods with intricate shapes, thin films or goods with substantial variation in polymer thickness may preclude use of larger presses, particularly in polymeric liquids filled with a high concentration of solid fillers. In many cases, the use of greater forces alters flow dynamics, which in turn can lead to significant defects such as melt fracture, sharkskin, die swell, viscous heating and degradation of polymer or additive, residual strain in the polymer chains or other defects that can affect product appearance, longevity or performance.

Larger presses may not be viable or affordable in many instances, so existing presses are operated at mechanical limits. This may solve an immediate processing problem; however, equipment life is significantly reduced, resulting in economic penalty. In other instances, such as reaction-injection molding, the polymeric liquid may not be amenable to molding under high forces.

Methods other than increasing press capabilities have been employed for combating the viscous nature of the polymeric liquids, but each has some adverse consequences. For example, the operating temperature is frequently increased to take advantage of the well-known decrease in polymer viscosity with increasing temperature. Such an approach has many potential adverse consequences:

First, the production rate of finished goods usually decreases because the cure time must be increased to compensate for a higher resin temperature.

Second, the degradation rate of the polymer will increase proportionally to e^{(-Ea/RT)} (where Ea is the energy required for polymer breakdown, R is the gas constant and T is temperature in degrees Kelvin). As the temperature increases, so does the degradation reaction rate.

Third, temperature-sensitive additives mixed with polymers also are more likely to degrade because degradation reactions have the same proportionality to temperature as do polymer degradation reactions.

Fourth, polymerization reaction rates are proportional to the same factor of e^{(-Ea/RT)}. An increased temperature can result in unacceptable reaction rates or result in a finished polymer with various physical defects or lower physical/mechanical properties (e.g., impact strength, heat deflection temperature, etc.).

Fifth, for semicrystalline polymers such as polyolefins, nylon, etc., an increase in the operating temperature will decrease the number of nucleation sites and alter the length of time for cooling. Either of these effects may substantially alter the crystallization of the polymeric liquid, which in turn, alters physical/mechanical properties of the finished polymer.

Sixth, for amorphous polymers or amorphous components of semicrystalline polymers, a higher processing temperature may result in significantly more residual stress in the finished polymer. Quenching of the molten polymer during a cooling cycle traps a molecule in the strained state. This internal strain can substantially decrease the physical/mechanical properties and dimensional stability of the finished polymer.

Alternatively, thermoplastic molders may adopt a different strategy by changing to a polymer with a higher Melt Flow Index (MFI). The viscosity of a polymer is inversely proportional to the MFI, i.e., a polymer with a higher MFI will have a lower viscosity. There are consequences of such a choice, however. The MFI of a given polymer (e.g., polypropylene) is inversely proportional to the molecular weight of the polymer—the higher the MFI, the lower the molecular weight. Unfortunately many mechanical properties of a polymer are directly proportional to the molecular weight. Therefore, selecting a polymer with a higher MFI to achieve a better melt flow, will of necessity, decrease mechanical properties such as strength, impact resistance and heat deflection temperature (HDT) of the finished polymer. Thus, molders are confronted with tradeoffs—how much can the MFI of the polymer be increased to improve molding capabilities without compromising the desired mechanical properties of the finished goods?

Molders have tried other techniques to increase the flow of polymeric liquids, particularly the use of additives, classified generally as lubricants or plasticizers. Internal lubricants generally are soluble in the polymer and are composed of synthetic resins, organic acid derivatives, fatty acids/modified fatty acids, glycerides/fatty glycerides, modified esters, waxes, and/or other organic or organometallic compounds. Typically, these materials have a relatively low molecular weight (˜10³ gms/mole) as compared to the high molecular weight of, say, high density polyethylene (HDPE; 10⁶ gms/mole). Such additives typically melt below molding temperatures of the polymer, so the additives become a low viscosity liquid dispersed in the molten polymer. The principal problem of these additives is that they lower the average molecular weight of the polymer melt. For example, the presence of 1 gm of an additive (10⁻³ moles) in 10⁴ gms of HDPE (10⁻² moles) represents only a 0.01% concentration by weight; however, the molecular concentration of the additive is 10% of the base HDPE polymer. For semicrystalline polymers, low molecular weight molecules can disrupt crystallite growth and/or lower the average molecular weight of amorphous inter-crystallite material. Either of these effects may reduce the physical/mechanical properties of the finished polymer. For an amorphous polymer, a low molecular weight additive lowers the average molecular weight of the polymer. This in turn can reduce the glass transition temperature (T_{g}), an important indicator of the ability of the resin to withstand elevated temperatures. A similar lowering of T_{g} occurs in thermoset polymeric liquids if the additive is not consumed or destroyed by a cross-linking reaction during the curing process. Even if loss of mechanical properties were acceptable, internal lubricants are not particularly desirable because each formulation is applicable to only a limited range of polymer compositions.

For thermoset polymeric liquids, the use of additives to modify viscosity is often incompatible with required polymerization reactions. Alternatively, additives may affect the physical/mechanical properties of the finished article.

External lubricants differ from internal lubricants because they melt during processing and migrate to the surface because of insolubility in the polymeric liquid. The external lubricant forms a low-viscosity boundary layer between the high-viscosity polymeric liquid and the stationary walls of processing equipment. Some of the more effective external lubricants are fluorine-based polymers; however, serious environmental risks are associated with their manufacture. In addition, insoluble external lubricants, such as siloxanes used with polyolefins, can bloom to the surface of the finished goods well after molding, thus creating undesirable surface contamination.

Plasticizers can be used for certain polymers such as polyvinyl chloride (PVC) and polyethylene (PE). Plasticizers (usually non-volatile liquids) may reduce the viscosity of the polymer; however, physical/mechanical properties of the resultant polymer are unlike the polymer without plasticizer. For example, PVC without plasticizers forms a rigid product, but PVC with plasticizers may form a highly flexible product.

In sum, current methods of polymeric liquid viscosity modification are not able to reduce the viscosity without having serious adverse impact on physical/mechanical properties durability, production rate, processing method and/or performance of the finished polymer.

The polymer industry makes widespread use of solid, flexible or molecular additives to a base polymer to reduce cost or to improve physical/mechanical properties of the finished polymer. Many of these additives serve a single purpose, such as inexpensive fillers to reduce material cost for an article, solid reinforcing fillers to improve mechanical strength properties of the finished polymer, elastomers to improve impact strength, etc. Although the additives are capable of achieving their objective, fillers increase the viscosity and make the polymeric liquid more difficult to process and elastomers are often difficult to disperse and distribute, thus resulting in inconsistent physical/mechanical properties.

One of the persistent problems with many additives is an inconsistent or unstable dispersion (i.e., separation of additive particles or molecules from one another and wetting of each by the polymeric liquid) and/or distribution (uniform spacing of additive particles or molecules throughout the polymer matrix). If an additive is mildly or strongly incompatible with the polymeric liquid matrix (e.g., polar additive in a non-polar polymer), there is a tendency for the additive particles or molecules to agglomerate to one another rather than being dispersed and distributed. Agglomeration of additives is highly undesirable because there are fewer additive particles or molecules per unit volume and, therefore, less effectiveness of the additive. Several different approaches have been used to prevent agglomeration of additives. One of these approaches, for example, uses costly chemical modification of the additive to increase the compatibility of the additive with the polymer.

A further challenge to the polymer processing industry is a continual need to remove contaminants from wetted surfaces in processing equipment. In spite of good processing practice, polymer degradation products and some additives and pigments plate out or accumulate on wetted surfaces. These coatings are potential contaminant sources that must be removed periodically. Typically, removal requires chemical treatment and/or processing of abrasive polymers. For either treatment, processing equipment is taken out of service and often requires additional out-of-service time to purge cleansing agents before production can resume.

There is an industry-wide need for a technology that will provide improved processability of polymeric liquids while at the same time affording modest if not substantial improvement in physical/mechanical properties of the finished polymer, dispersion and distribution of additives and purging of contaminants from processing equipment. The technology needed would advantageously: (1) modify the viscosity of the polymeric liquid; (2) be effective in a wide spectrum of polymeric liquid types; (3) be effective at typical temperatures, pressures and conditions in a wide diversity of processing methods that may be used for finishing a polymer type and grade; (4) not adversely degrade the finished polymer relative to its intended application; (5) not interfere with beneficial reactions, if any; (6) not adversely affect but possibly enhance physical/mechanical properties of the finished polymer; (7) be able, through selection of an additive with appropriate composition, concentration, particle size range and physicochemical characteristics, to enhance polymeric melt processing for the physicochemical conditions extant in the intended finishing environment with or without affecting physical/mechanical properties of the finished polymer; (8) be able, through selection of an additive with appropriate composition, concentration, particle size range and physicochemical characteristics, to enhance the physical/mechanical properties of the finished polymer with or without affecting the viscosity of the polymeric liquid, (9) be able, through selection of an additive with appropriate composition, concentration, particle size range and physicochemical characteristics, to increase dispersion and distribution of other additives (including but not limited to pigments, UV stabilizers, impact modifiers, flame retardants, etc); (9) improve recycling of mixed grades of a single polymer type or commingling and mixing of dissimilar polymer types; (1) enhance continuous purging of degraded polymer and/or additives from wetted surfaces of processing equipment.

Preparations (referred to herein as A1 and A2) of a solid material of naturally occurring aluminosilicate glass has been available for amending the viscoelastic properties of thermoplastics. The solid material and its employment are disclosed in U.S. patent application to Jess Booth et al. entitled SYNTHETIC THERMOPLASTIC COMPOSITION ARTICLES MADE THEREFROM AND METHOD OF MANUFACTURE, U.S. Ser. No. 10/036,159, filed Dec. 26, 2001, the disclosure of which is incorporated herein by reference.

### SUMMARY OF THE INVENTION

The present invention is directed to polymer compositions containing polymeric liquids and viscosity modifiers. Also provided are methods of using and preparing the polymeric compositions, and methods for selecting and identifying solid materials for viscosity modification.

In a first separate aspect of the present invention, the polymeric liquid is provided in composition with a viscosity modifier which is a solid material. The solid material is at a concentration of less than 2% by weight of the composition. The particles comprising the material are less than about 75 microns equivalent spherical diameter. The material is of an amorphous content of greater than about 93% by weight.

In a second separate aspect of the present invention, the polymeric liquid is provided in composition with a viscosity modifier which is a solid material. The polymeric liquid is selected from the group consisting of a thermoset polymeric liquid and a thermoplastic vulcanizate polymeric liquid. The solid material is at a concentration of less than 2% by weight of the composition. The particles comprising the material are less than about 75 microns equivalent spherical diameter.

In a third separate aspect of the present invention, he polymeric liquid is provided in composition with a viscosity modifier which is a solid material. The solid material is at a concentration of less than 2% by weight of the composition. The particles comprising the material are less than about 75 microns equivalent spherical diameter. Excluded from this viscosity modifier is a preparation of naturally occurring aluminosilicate.

In a fourth separate aspect of the present invention, a method of lowering the viscosity of a polymeric liquid includes the dispersion of a viscosity modifier throughout a polymeric liquid. The modifier comprises a solid material at a concentration of less than about 2% by weight of the composition with particle sizes of less than about 75 microns equivalent spherical diameter and an amorphous content of greater than about 93% by weight.

In a fifth separate aspect of the present invention, a method of lowering the viscosity of a polymeric liquid includes providing a polymeric liquid selected from the group consisting of thermoset polymeric liquid and thermoplastic vulcanizate polymeric liquid and a viscosity modifier dispersed and distributed throughout the liquid. The viscosity modifier is solid material at a concentration of less than about 2% by weight of the composition. The particle sizes of the solid material are less than about 75 microns equivalent spherical diameter.

In a sixth separate aspect of the present invention, any of the foregoing aspects are contemplated to be employed in combination to greater advantage.

Accordingly, it is a principal object of the present invention to provide improved composition and methods for lowering the viscosity of polymeric liquid. Other and further objects and advantages will appear hereinafter.

### BRIEF DESCRIPTION OF THE DRAWINGS AND TABLES

FIG. 1 shows a flow chart of a process for preparing an additive for modifying the viscoelastic properties of a polymeric liquid;

FIG. 2 shows tensile elastic modulus vs. temperature for a representative polymer system with and without a solid additive;

FIG. 3 shows the zero shear viscosity for a representative polymer system;

FIG. 4 shows the critical stress determination of a representative polymer system;

FIG. 5 shows the effect of a filler on viscosity and critical stress value;

FIG. 6 shows the effect of a solid material on critical stress value;

FIG. 7 shows the enhanced processing window for a representative unfilled polymer system;

FIG. 8 shows the enhanced processing window for representative filled polymers;

FIG. 9 shows the effect of temperature on the complex viscosity of NEAT and solid-bearing polymer;

FIG. 10 shows the effect of increasing temperature on the enhanced processing window;

FIG. 11 shows the effect of solid material concentration on viscosity;

FIG. 12 shows the effect of particle mesh on complex viscosity;

FIG. 13 shows the effect of particle shape on complex viscosity;

FIG. 14 shows the effect of glass content on complex viscosity;

FIG. 15 shows the variation in critical stress value reduction as a function of melt-flow index;

FIG. 16 shows the effect of UV light exposure on color;

FIG. 17 shows the effect of solid material on mold fill time at different injection speeds;

FIG. 18 shows the effect of 9-15 micron particle size range on complex viscosity versus a 800-mesh standard;

FIG. 19 shows the effect of 5-9 micron size fraction as compared to 800-mesh standard on complex viscosity;

FIG. 20 shows the complex viscosity as a function of stress for polymer with different solid materials;

FIG. 21 shows the effect of particle characteristics on dynamic tensile elastic modulus;

Table 1 shows the zero-shear viscosity of polypropylene and solid material formulations;

Table 2 shows the complex viscosity of polypropylene and solid material formulations as a function of stress;

Table 3 shows polymer compositions which exhibit decreased complex viscosity in the molding environment;

Table 4 shows the physical/mechanical properties of an impact-modified polyolefin copolymer;

Table 5 shows the physical/mechanical properties of polypropylene as a function of solid additive and temperature; and

Table 6 shows the physical/mechanical properties of a thermoset urethane.

### DETAILED DESCRIPTION OF THE PREFERRED EMBODIMENTS

A polymeric liquid as used herein is a precursor to a finished article composed of a polymer. The polymer can be a thermoset polymer, a thermoplastic polymer, or a thermoplastic vulcanizate. A polymeric liquid can be classified as a thermoset polymeric liquid, a thermoplastic polymeric liquid or a thermoplastic vulcanizate polymeric liquid, depending on the type of polymer produced. Such polymeric liquids are well known in the art. Any of the polymeric liquids can contain one or more recycled polymers.

A viscosity modifier comprises (a) a solid material active in lowering the viscosity of the polymeric liquid, and (b) any added substance. Of particular interest are solid materials that have particle sizes of less than about 75 microns equivalent spherical diameter (where “equivalent spherical diameter” is a well known term in the art for relating particle size) and are present in the composition at a concentration of up to about 2% by weight of the composition. In particular embodiments, at least about 50% by weight of the solid material has a Mohs hardness value in the range of about 3-6.

The preferred embodiment is directed to the addition of less than 2.0 percent by weight of solid particles of less than about 75-microns diameter (equivalent spherical diameter as determined by volume-displacement measurement method; all references hereafter to particle sizes are in equivalent spherical diameters) to a polymeric liquid with the selection of an appropriate solid material for the intended application, the appropriate milling and beneficiation of the solid material for maximum beneficial effect, measurement of the effect of the solid material on the polymeric liquid, the achievement of production on an industrial-scale, and the deliberate modification of solid material characteristics to achieve specific processing improvements. Thus, the polymer processing industry is challenged by a number of and often interdependent optimizing considerations such as: (1) how to induce flow in an often highly viscous liquid so finished articles may be produced economically and rapidly, (2) how to efficiently disperse and distribute functional additives in a polymer or improve mixing and commingling of recycled polymers, (3) how to affect the physical/mechanical properties of the finished article and (4) how to prevent or correct build-up of contaminants such as degraded polymer or additives from wetted surfaces in processing equipment.

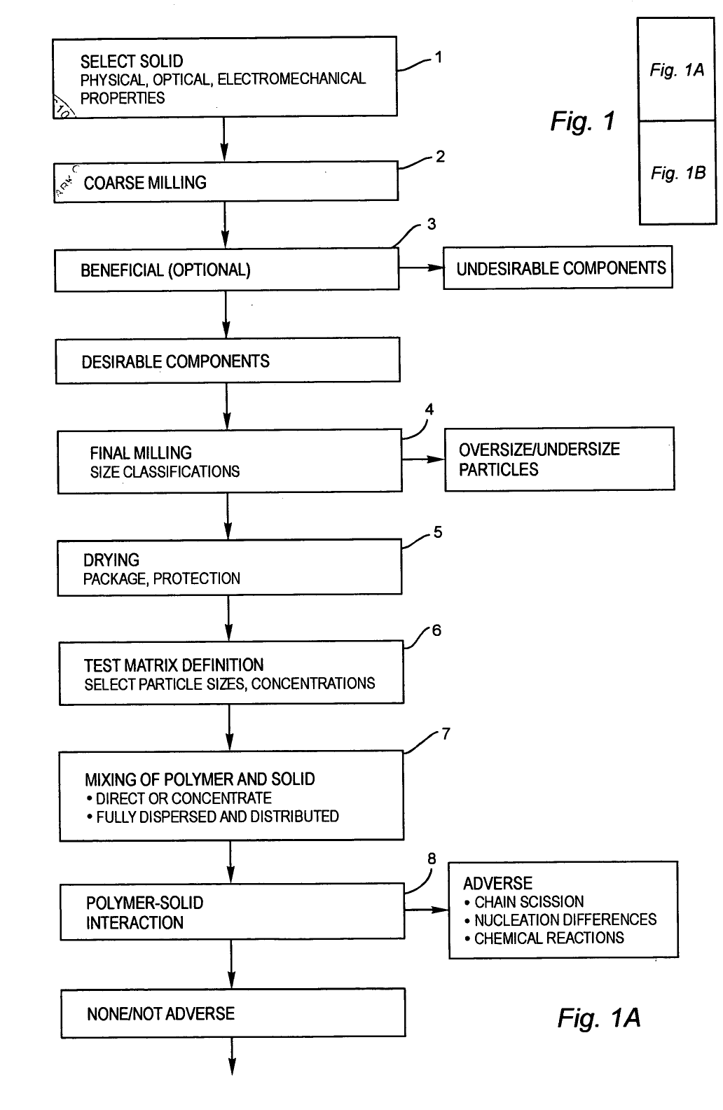

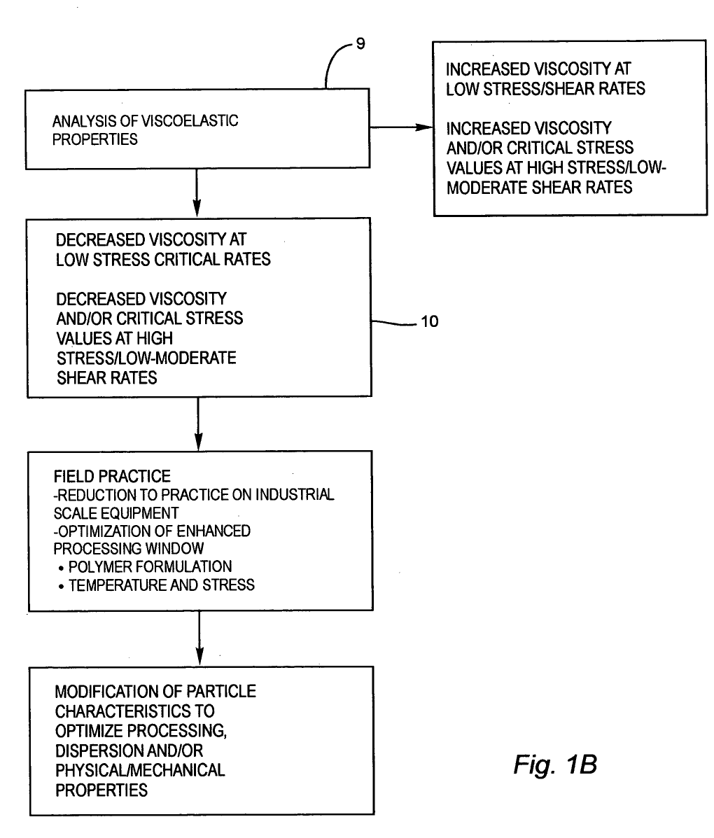

Referring to FIG. 1, step 1 of the process is selection of a solid material. The ability of a solid material to achieve some or all of the stated objectives is directly related to physicochemical (physical and chemical) properties of the solid material. Unfortunately, adverse attributes are also related directly to physicochemical properties of the solid material. Although the solid material, A1-A2, is highly effective in addressing the four objectives and has few adverse effects, solid materials with different compositions can achieve some or all of the same objectives and may be even more effective in some polymer compositions.

Several physiochemical properties are evaluated when selecting the solid additive to eliminate undesired effects of the solid material on the finished polymer. The evaluation of physicochemical properties may include but is not limited to the following.

First, the hardness of the solid material should be evaluated as determined by the relative numeric Mohs hardness scale, with talc=1 and diamond=10. In a preferred embodiment, solid materials with hardness of about to 3-5.5 are chosen. Materials with hardness approaching or exceeding 6.5 may be effective but are not desirable because they are abrasive to hardened chrome plating (hardness=6.0-6.5) that is used to protect more vulnerable steel (hardness=5+) or other metals in polymer-processing equipment. Materials with a hardness less than 3 appear less effective in addressing the four stated objectives.

Second, the particle shape of the solid material is evaluated. In a preferred embodiment, particles with an aspect ratio (width:length) of about 0.6 or greater are utilized. Furthermore, particles of irregular geometric shape with an aspect ratio of about 0.6 or greater are more effective in creating beneficial modification of polymeric liquid properties than regular geometric shapes such as squares, rectangles or spheres. Particles with aspect ratios of less than 0.6 (needle, prismatic or bladed shapes) typically increase polymeric liquid viscosity and are less effective in addressing the other stated objectives.

Third, morphological features on the surface of particles are important in their interaction with the polymer. In a preferred embodiment, particles with a hackly (sharply uneven) or uneven surface morphology are far more effective in addressing the four stated objectives than particles with very smooth, curved fracture surfaces.

Fourth, the internal structure of the particle is considered. In a preferred embodiment, amorphous materials are utilized because they do not promote nucleation of crystallites in semi-crystalline polymers. Crystalline materials may be used, however, if changes in physical/mechanical properties of the semi-crystalline polymer are beneficial. In other applications such as thermoset polymers, modification of polymeric liquid viscosity may be less important than increasing physical/mechanical strength properties of the finished polymer. As described below, two chemically identical materials, one crystalline and the other amorphous, have different effects on the strength of the cured polymer. The crystalline variety increases polymer strength whereas the amorphous variety does not.

Fifth, the electrochemical surface properties of the particles influence the ability of a solid material to effectively interact with polymer molecules and affect the polymer viscosity and/or physical/mechanical properties of the finished polymer. In a preferred embodiment, the polymer adherence to solid particles is evidenced by scanning electron microscope imaging of the particle-polymer interface. Typically, organic polymers are not expected to wet the surface of inorganic particles due to their profoundly different chemical compositions and structures. Effective solid materials appear to be fully wetted by the polymer.

Finally, the chemical reactivity of the solid material with the polymer molecules is evaluated. In a preferred embodiment, the solid material does not result in chemical reactions that result in adverse effects on the polymer composition or polymer properties (e.g., decreased physical/mechanical properties, decreased useful service life). Furthermore, any chemical reaction is not to interfere with or decrease the performance of any additive nor should the solid particles adversely affect beneficial chemical reactions (e.g., crystallite nucleation, crosslinking, in situ polymerization).

Other solid material properties may not be significant in terms of their effect on achievement of the four stated objectives; however, they can have substantial impact on other properties of the polymer. For example, strongly colored solids will alter the color of the finished polymer whereas opaque particles will reduce or eliminate the clarity of a transparent polymer. In some applications, the electrical conductivity of the polymer may be a critical performance characteristic. Even though the concentration of solid particles is low, a solid material with high or low electrical conductivity may substantially alter, either adversely or beneficially depending on the application, the conductivity of the polymer.

A final example of a property of the potential solid additive that may not address the four stated objectives but can have a dramatic effect on the final polymer product is chemical toxicity of the solid material. In a preferred embodiment, the solid particles have no toxicity. Even though the solid material appears to be fully wetted by the polymer when properly dispersed and distributed, leaching of elements or chemical species from a potentially toxic solid material could make the finished article hazardous.

Referring to FIG. 1, step 2 is coarse milling. Coarse milling is typically required when the solid particles are too large to proceed to final milling in FIG. 1, step 4. In a preferred embodiment, coarse milling is used for materials that contain more than one phase, one or more of which is (are) to be eliminated from the final product. The objective is to coarse mill the product with multiple phases such that the undesirable phase or phases are larger or smaller in diameter than the desirable phase or phases. For example, a natural material containing glass and crystalline phases is coarsely crushed in a Raymond mill such that the glass is reduced to particle diameters less than 100 microns whereas more durable crystalline phases are greater than 100 microns. Such a preparation allows for beneficiation of the material. Coarse milling typically consists of incrementally reducing the particle size of the raw product in one or more operations, either to prepare the material for final milling or for beneficiation. Coarse milling methods may include but are not limited to jaw crushing, cone crushing, roller milling (such as Raymond mill), or ball milling.

Referring to FIG. 1, step 3 is beneficiation. Beneficiation is a procedure to increase the concentration (weight percent) of a desirable phase (or phases), usually by segregation of undesirable phase(s) into a separable fraction. In a preferred embodiment, coarse milling as described above results in particle size differences between desirable and undesirable phases. Screening or classification may be used to separate the two size fractions, thus beneficiating one fraction. Depending on the characteristics of the undesirable phase(s), other methods may be employed. For example, iron-bearing minerals are often undesirable because of their dark color and chemical instability; however, they are often magnetic and can, therefore, be separated from non-magnetic components with commercially available magnetic separators. Alternatively, desirable and undesirable components may have substantially different densities and may be separated by commercially available devices such as centrifugal separators or riffle tables. Another method is to take advantage of the differing chemical properties of the phases by selectively treating one or more phases and then separating them in flotation cells.

Referring to FIG. 1, step 4 is final milling. Final milling is important because it determines particle shape, surface morphology and particle-size range. Each characteristic has a direct effect addressing the four stated objectives. Depending on physical properties of the solid material, a preferred irregular particle shape with an aspect ratio of 0.6 or greater may be achieved by methods such as but not limited to jet milling, dense-phase fluid-bed milling, roller milling, ball milling or plate milling. It is desired to produce particles with a hackly or uneven surface morphology.

Final milling to less than about 75 microns, and in a preferred embodiment, particles sizes less than about 15 microns are desirable to address most or all of the stated objectives. Particle size classification can be achieved by commercially available technologies such as turbo classifiers, air classification or other methods. Depending on the intended application and desired effect of the solid material on the polymer, the solid material can be classified to have a maximum particle size, a minimum particle size, a selected minimum and maximum particle size, or a selected mean, median or modal size within a range. By careful balancing of variables, including total surface area as determined by size, number of particles and morphological properties, the solid material can be designed for a specific polymeric liquid, specific viscoelastic effect, specific dispersion and distribution characteristic, specific modification of physical/mechanical properties of the finished polymer, or specific enhancement to purging of processing equipment.

Referring to FIG. 1, step 5 is drying. Drying is important depending on polymer composition, sensitivity of other additives to moisture and molding method. This step can be adjusted depending on the specific polymer/additive system and polymer finishing method.

In a preferred method for injection molding of polyolefins, the solid material typically contains less than about 1 percent by weight of adsorbed moisture (i.e., moisture released by heating to 105° C.). Excessive moisture content may cause surface defects such as splay, internal defects such as bubbles, decrease in physical/mechanical properties or reduced efficacy of other additives. In film applications, however, the moisture content is preferably less than about 0.25 weight percent. The presence of surface moisture on a particle can result in poor wetting of the solid material surface by the polymer. Poor adhesion of the polymer to the solid particle may cause the particle to fall out with a potential for collapsing the film bubble. The final product, with holes, could not be used for many applications. Alternatively, the adsorbed moisture can cause film thickness variation or even holes due to differential cooling rates.

Other polymers such as polycarbonate or nylon are more sensitive to the presence of moisture, usually because the presence of moisture can result in polymer degradation or additional opacity. Depending on the polymer and molding method, post-milling drying at temperatures of 100-140° C. for up to 24 hours, with or without vacuum, may be required to reduce adsorbed moisture to less than about 0.25 weight percent.

Transparent polymers, whether sensitive to moisture or not, are a special case. In the case of these polymers, moisture adsorbed on the solid material may be vaporized, thus resulting in bubbles in the polymer. Typically, in molding, the curing of the finished polymer is so rapid the bubble is frozen in, even though the moisture may condense. The bubbles diffract light transmitted through the polymer, which is recognized by a decrease in transparency (i.e., haze. Similarly, the moisture content is preferably below 0.25 weight percent.

Referring to FIG. 1, step 6 is a critical step to determine whether a solid-polymer formulation based on preferred particle characteristics outlined above is able to address desired objective(s). A preferred method is to screen solid-polymer formulation performance characteristics on a laboratory scale, then evaluate on industrial-scale equipment Although correlations exist between laboratory-scale and industrial-scale equipment performance characteristics, those achieved on larger and more complicated industrial-scale processing equipment may not have a linear correlation with laboratory-scale results. Therefore, it is preferred that laboratory-scale testing be confirmed with industrial-scale testing.

In a preferred method, a series of milled solid material samples is prepared by classification of particles into narrow size ranges (e.g., 5-9 microns). The entire set of samples would then cover the range of interest, for example <1 to 45 microns. In this case, each sample will accurately portray the effect of that size range on size-dependent performance characteristics such as polymeric liquid viscosity, dispersion/distribution and/or physical/mechanical properties of the finished polymer.

The performance characteristics are further evaluated for the effect of a second variable, solid concentration, on performance characteristics. At least for initial screening purposes, concentrations up to 1 weight percent are preferred.

The combined effect of particle size range and concentration on each performance objective will address development of a specific formulation to achieve a narrow objective such as modification of the low stress/low shear-rate viscosity or a more general formulation that addresses multiple objectives.

Referring to FIG. 1, step 7, compounding of the solid additive and polymer is now described. Compounding of the solid material and polymer is an important step because the performance characteristics of the solid-polymer formulation are accurately established only when the solid material is completely dispersed and uniformly distributed into the polymer.

Compounding of the solid material and polymeric phase should occur as far upstream as practical in the manufacture of the polymer or polymer precursor. If an appropriate solid material has been selected, it will not undergo any significant change during various manufacturing steps; therefore, polymer-solid performance characteristics will persist as long as dispersion and distribution are maintained. Furthermore, desirable polymer-solid performance characteristics such as modified viscosity or lower processing temperature would be available during all subsequent manufacturing steps or even upon recycling.

It is conceivable that the solid material could be added prior to polymerization of thermoplastics or the non-productive polymerization stages of thermosets. If a solid material has stoichiometric similarity to a catalyst support required for polymerization, the solid material could substitute for the catalyst support. Even if the solid material cannot substitute for the catalyst support, insertion of the solid material in the reactor or just after the reactor will provide performance enhancements downstream.

More typically, however, the solid material and polymer are compounded at some point farther downstream in the manufacturing process. The compounding method depends on the physical state of the polymer. If the polymer is a relatively low viscosity liquid at room temperature, such as some thermoset resins, compounding of the solid material and polymeric liquid may be achieved with low- or high-shear mixers, two- or three-roll mills, sand mills, etc. High-viscosity liquids such as thermoset rubbers may require specialized equipment such as a Banbury mixer. Thermoplastic polymers, which are essentially solid at room temperature, must be heated to a typical processing temperature and processed under substantial shear and mixing. In a preferred method for such thermoplastics, the solid material is dry added to a polymeric liquid in a twin-screw extruder, thoroughly dispersed and distributed and then extruded into pellets that are used in the final molding stage. In some instances, the solid material cannot be added to the polymeric system until the final molding stage. In this case, the preferred method is to add the solid material via a concentrate pellet (15-50 weight percent solid material). The concentrate pellet contains dispersed solid particles in a binder or a carrier polymer that may also contain other additives. Complete dispersion and uniform distribution are essential for establishing an optimal effect of solid particles. For example, the productivity of an extrusion line with a solid-polyvinylchloride (PVC) formulation decreased by about 20 percent when a screw with a less intense mixing element was substituted for a screw with an aggressive mixing element.

Referring to FIG. 1, step 8, the polymer/solid system is screened to determine if polymer degradation (chemical change) has occurred. The primary purpose here is to ascertain whether changes in the four stated performance objectives are a result of chemical changes in the polymer or are a result of primarily non-chemical interaction of solid particles and polymeric liquid. Preferably, changes in polymer performance characteristics are a result of a largely physical interaction of solid particles and polymeric liquid rather than a chemical change that would have adverse effects on polymer properties.

Any one of a number of analytical methods can be used to determine the polymer integrity when formulated with solid particles (i.e., chemical similarity of the polymer before and after formulating with the solid particles). Four sensitive and accurate analytical methods described below are examples of numerous methods that can be used to determine polymer integrity. Some of the same methods can be used to determine changes in polymer performance characteristics as a result of the solid additive.

Gel Permeation Chromatography (GPC): A polymer typically consists of molecules with differing chain lengths and hence different molecular weights. GPC is one of the most sensitive methods for detecting the molecular weight distribution of a polymer. The polymer is dissolved in an appropriate solvent and analyzed for the molecular weight distribution. If a polymer has undergone degradation by chain scission, the average molecular weight M_{z} could decrease or the molecular weight distribution could be skewed towards lower molecular weight molecules. If, on the other hand, the polymer has undergone further polymerization, the average molecular weight M_{z} or molecular weight distribution could increase.

As an example of this analytical technique, a polycarbonate polymer with a narrow molecular weight distribution was compounded in a compounder-extruder with 1-5 weight percent solid material. The polymer was solvent-extracted from the solid material and analyzed by high-pressure liquid chromatography using a linear GPC column. The average molecular weight (M_{z}) and weight-average molecular weight (M_{w}) for the polycarbonate compounded with the solid material were not detectably different than values for the polycarbonate compounded without the solid additive. At least within limits of the analytical method, compounding with an appropriate solid material should not create molecular weight differences that could affect the polymer properties or polymer performance characteristics.

Nuclear Magnetic Resonance (NMR) spectroscopy: ¹H and ¹³C NMR spectroscopy is very sensitive for detection of other organic compounds or salts of organic compounds that could result from reaction of polymer fragments with each other or the solid material. Formation of free radicals from the polymer chain, free radicals from the solid material, elements or ions from the solid material, or elements or solids from the atmosphere could combine with the polymer chain, creating new compounds with different ¹H and ¹³C resonance lines. The potential for chemical reactions varies greatly between different polymeric liquid types, but is probably of most concern in instances when a highly viscous polymeric liquid (e.g., thermoplastic, rubber, or highly filled non-cross-linked thermoset) is compounded or processed with a solid material at elevated temperature and/or shear stress.

As an example of this analytical method, the chemical composition of LLDPE compounded with a solid material (e.g., a 50 weight percent solid concentration) was analyzed by high-resolution NMR spectroscopy and compared to the composition of LLDPE compounded without a solid material. Even with extended periods of polymer-solid compounding, there were no detectable differences between the NMR spectra of polymer compounded with solid material and polymer compounded without solid material. This indicates that any changes in LLDPE performance properties cannot be attributed to formation of other compounds. By extension, similar results are an integral part of any combination of polymeric liquid and appropriate solid material, that is, the solid material should not materially alter the chemical composition of the polymeric liquid.

Differential Scanning Calorimetry (DSC): Thermoplastic polymeric liquids that partially crystallize upon cooling (i.e., they are classified as semi-crystalline polymers) have properties that are largely dependent on the number and size of crystallites. Many chemical compounds and solid materials are known to affect the nucleation of the crystallites as well as the kinetics of crystallization. Any change in crystallite structure or abundance can have an adverse impact on polymer properties, so it is essential that the effect of the solid additive on crystallite structure be carefully evaluated by an analytical method such as DSC. In the DSC method, enthalpy changes are determined as a function of rising or falling sample temperature and are plotted in what are typically called heating or cooling curves. Melting of crystallites such as in a semicrystalline polymer during a rise in temperature decreases the enthalpy release, whereas, growth of crystallites increases the enthalpy release. The temperature at which crystallites begin to melt or form as well as the range of temperature over which crystallites melt or grow are used typically to determine the abundance and size of crystallites. However, if the molecular weight distribution of two polymers is different or the solid material inhibits or accelerates crystallite nucleation or growth kinetics, the onset and range of melt or crystallization temperatures and enthalpy changes will differ due to the presence of low molecular weight polymer molecules or changes in crystallite nucleation and growth rates.

As an example of this analytical method, LLDPE was compounded with up to 20 weight percent of a solid material and the heating-cooling curve was compared to a polymer compounded without a solid material. Within analytical uncertainty limits, there was no detectable change in the melting or crystallization temperature of the two polymers and enthalpy changes were proportional to polymer concentration. This indicates that compounding of LLDPE with an appropriate solid material has not resulted in formation of lower molecular weight compounds or affected the nucleation and growth of crystallites. Comparable results have been obtained on polypropylene and nylon. By extension, other polymeric compositions should show comparable results except in the instance where there is a deliberate intention to alter the properties of the finished polymer by selecting a solid additive that changes the crystallite size and number in a beneficial manner.

Mechanical Thermal Analysis (MTA): A number of physical/mechanical properties (e.g., elastic modulus, flexural modulus, creep resistance, etc.) of finished polymers are sensitive to the molecular weight distribution of the polymer, and for semi-crystalline polymers, the number and size of crystallites. When formulating solid-polymer compositions, the goal is to have no adverse effect on the molecular weight distribution or crystallite size and number. A preferred method, dynamic mechanical-thermal analysis (DMTA), is presented as an example of how physical/mechanical properties of a finished solid-polymer formulation can be utilized to determine whether polymer integrity has been maintained.

In the DMTA method, the tensile elastic modulus of semicrystalline polypropylene is determined over a range of temperatures below the melting temperature. If processing of the polypropylene with a solid material resulted in a lower molecular weight distribution or adversely affected crystallite nucleation or kinetics, the elastic modulus would be lower at the same temperature than that of the polymer processed without the solid additive.

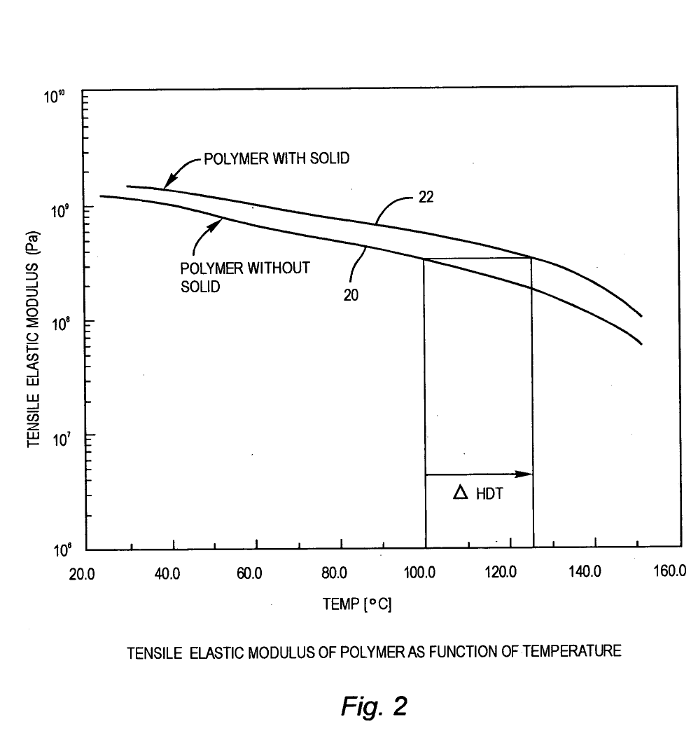

A typical DMTA result is shown in FIG. 2. The tensile elastic modulus is plotted as function of temperature for NEAT (nothing Else Added To) polypropylene (PP), curve 20, and a sample of PP with a solid, curve 22. Some 35 different solid-polymer-formulations, with varying particle size, weight percent solid and solid composition were analyzed and compared to NEAT PP.

For most solid-polymer formulations, the tensile elastic modulus is uniformly higher than NEAT PP over the temperature range. Parallel curves for NEAT and solid-bearing PP suggest that crystallization of the polymer has not been significantly affected by the presence of the solid material. Of more significance, however, is the fact that in nearly all instances, the elastic modulus for the solid-bearing samples is higher than that of NEAT polymer at the same temperature. A higher elastic modulus indicates that the solid-bearing polymer does not contain lower molecular weight compounds or polymer degradation products.

Referring to FIG. 1, step 9, the viscoelastic properties of the polymer/solid additive system are evaluated. The viscoelastic properties of the polymeric liquid are believed to be the most important determinant as to whether the stated objective(s) can be addressed. The analytical approach is simple, the viscoelastic properties of the polymer-solid formulation are compared to similarly processed NEAT polymer. The specific interests are to determine relative changes in performance characteristics as a function of physicochemical conditions extant during processing and solid-polymer formulations with differing particle characteristics (size, composition, concentration).

Polymers and polymeric liquids have well known and simultaneous viscous (non-recoverable) and elastic (recoverable) responses to applied stress. Our interest in step 9 is primarily in the viscous properties of the polymeric liquid. The viscosity of the liquid determines whether improvements in polymer processing such as better mold fill, reduced melt temperature, improved dispersion, etc. can be achieved. The elastic properties are more relevant to finished polymer performance and are considered in step 10.

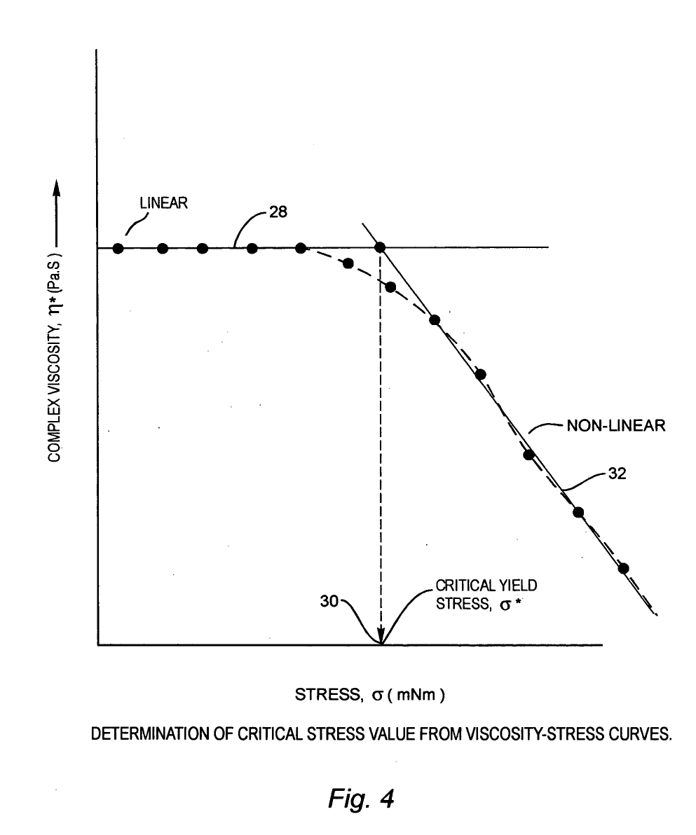

The polymer-processing environment encompasses an extremely diverse range of stresses and strain rates; therefore, variation of polymeric liquid viscosity as a function of stress amplitude and strain rates are to be determined. Referring to FIG. 4, polymers subjected to low stress amplitudes exhibit Newtonian behavior in that there is a linear relation between the stress and strain rate, as shown by portion 28 of the curve in FIG. 4. This is often expressed as [σ=η(\dot{γ})] where σ=stress, η=coefficient of viscosity, and \dot{γ} is the shear rate. Within a linear stress-strain regime, η is a constant. As stress increases, a stress amplitude is achieved at which the linear relation no longer applies. This amplitude is known as the critical stress value 30, σ*. At stresses above σ*, viscosity is no longer constant but rather depends on the applied stress, as shown by portion 32 of the curve in FIG. 4. The transition from linear, Newtonian to non-linear, non-Newtonian behavior occurs over a finite range of stresses; therefore, it is necessary to extrapolate the straight-line parts of the viscosity-stress curves to an intersection that defines the critical stress value (σ*).

Determination of polymeric melt viscosity in the linear (low stress amplitude) and non-linear (high stress amplitudes) regimes is relevant to understanding the viscous behavior of polymeric liquids in the processing environment. The ability to affect the four stated objectives is dependent on a combination of viscous behaviors in different stress environments. Some processing environments (e.g., rotomolding, slush molding, thermoforming) are characterized primarily by low stress and/or low strain rates. However, polymer formulations used in these stress environments are often processed in extruders/compounders that have both high and low stress environments. Other processing environments (e.g., injection molding) have both high stress (e.g., in the barrel) and low stress environments (e.g., in the mold).

It is well known that the viscous behavior of polymeric liquids at very low stress/strain rates (linear regime) is controlled dominantly by intrinsic properties of the polymer. Determination of the viscosity of solid-polymer formulations under these conditions reveals an unanticipated decrease in polymeric liquid viscosity. In high-stress/moderate strain-rate regimes, polymer viscosity is controlled by stress-induced thinning. At high stress/moderate strain rate conditions, the viscosity is also reduced—a counterintuitive result that is not anticipated based on a typical increase in viscosity when a high concentration (5-60%) of solid particles is present. The precise nature of mechanisms or combination of mechanisms responsible for lowering melt viscosity in these two very different stress/strain-rate regimes are not well understood. Nevertheless, they are considered to be separate effects of the solid particles. What is sufficiently well known is that characteristics of the solid material (e.g., chemical composition, particle size range, particle shape, concentration) have profound effects on polymeric liquid viscosity under the two different stress/strain regimes. Furthermore, methods are defined for evaluating and optimizing beneficial changes in processing properties under these two different stress/strain environments.

Advanced rheological analysis utilizing dynamic mechanical analyzers (DMA) allows for a rapid and accurate determination of how changes in compositional or environmental conditions affect the viscoelastic properties of the polymer. The ability to vary the frequency and magnitude of the stimuli, vary instrument design to measure different viscoelastic properties (e.g., tensile, shear, and flexural moduli), vary temperature, control stress or strain amplitude, etc. allows determination of many fundamental viscous and elastic properties. While the following describes the use of dynamic mechanical analyzers to determine viscoelastic properties of a polymer system, other techniques (e.g., steady state) may be used to acquire similar types of data.

An oscillating, parallel-plate torque rheometer was used to determine viscoelastic properties of differing polymer formulations. In the parallel-plate rheometer, a disk of polymer is placed in a temperature-controlled environment between two metal disks. One of the disks is stationary whereas the other is free to oscillate about a vertical axis. Software control of the instrument allows independent variation in temperature, oscillation frequency, stress amplitude or strain amplitude, thus allowing determination of a complete range of fundamental viscoelastic properties for the polymer.

The following describes the determination of the variation in the complex viscosity of polymer formulations for two different conditions: (1) under controlled strain (low stress amplitude/low strain rate) conditions for determination of complex viscosity in the linear regime down to vanishingly low shear rates (zero-shear rate) and (2) under controlled stress (higher stress amplitude/low to moderate strain rates) conditions to determine the complex viscosity in the transition from linear to distinctly non-linear stress-strain regimes. Models of how solid particles affect polymer viscosity have been developed for PP and PE based on laboratory-scale data. There are good correspondences between laboratory-scale and industrial scale results. Based on this correspondence, it is believed that industrial-scale results for an extremely diverse range of polymer compositions (Table 3) indicate that models developed for PP and PE are equally applicable to the other polymer compositions. Such an extrapolation is reasonable based on general properties of polymeric liquids.

Individual solid-PP formulations contain a wide variety of solids. The solids are either amorphous (A) or crystalline (C). The number following the A or C identifies materials of different composition. Unless indicated otherwise, the solid material concentration is 0.75 weight percent. The mesh size of milled products indicates that the solid material was classified after dense-phase milling to be a range of particles smaller than the indicated mesh size (for example, 325 mesh indicates that at least 95 percent of the particles are smaller than 325 mesh, or in this case, 45 microns, equivalent spherical diameter).

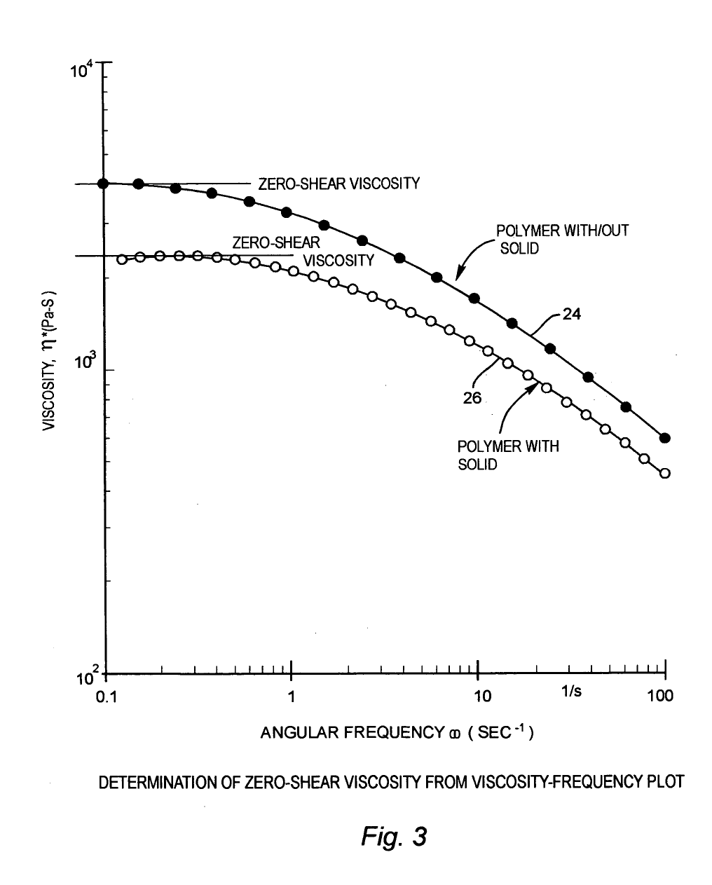

Results from low stress/low strain rate tests are summarized in Table 1. The zero-shear viscosity is described in FIG. 3, which shows curve 24 for a polymer without solid and curve 26 for a polymer with solid. The zero-shear viscosity has been determined for a NEAT PP homopolymer and a number of solid-PP formulations (Table 1). The complex viscosity of each sample was determined over a frequency range of 10⁻¹ to 10² sec⁻¹ on a parallel-plate torque rheometer under a maximum strain of 2 percent. A zero-shear viscosity was determined by extrapolating the complex viscosity to a vanishingly low frequency (approaching a zero-shear rate).

The principal and surprising result is that all solid materials, regardless of their composition but within the preferred concentration and size range of the present system, resulted in a lower viscosity under low stress/low shear rate conditions for solid-PP formulations than for NEAT PP (Table 1). A lower viscosity occurs over a range of shear rates (see FIG. 3) and presumably is present up to the proportional stress-strain rate limit. Referring to Table 1, the magnitude of the viscosity reduction is dependent on the following factors that are listed in decreasing order of independence from other factors:

(1) Temperature: the magnitude of decrease in the zero-shear viscosity increases with decreasing temperature. At 200° C., most solid-polymer formulations have a higher complex viscosity; however, most formulations have a lower viscosity than NEAT polymer at 180° C.

(2) Weight percent concentration: Varying the concentration of solid material increases or decreases the zero-shear complex viscosity (Group E). For 800-mesh solid A1, a concentration of 0.4 weight percent reduces the viscosity more than 0.75 weight percent

(3) Particle size: The viscosity is clearly dependent on particle size.A series of A1 samples were classified into narrow size ranges (Group D). Solid particles in the 5-9 and 9-15 micron size ranges are most effective in reducing the zero-shear complex viscosity

(4) Particle shape: Final milling of solid A1 and A2 clearly affect the viscosity (Group G). For example, particles of A2A have an aspect ratio and rough surface morphology as prescribed in this system. The viscosity of this solid-polymer formulation is substantially lower than a formulation containing A2B particles that have the same composition but inappropriate aspect and morphologic characteristics. Subtle differences in particle-size distributions for differing milling technologies may have some contribution

(5) Structure of solid material: The viscosity is sensitive to the relative amounts of amorphous to crystalline phases (Group C). Although the chemical compositions of the solid materials are nearly identical, a solid material with high amorphous content is more effective than a solid material with high crystalline content in reducing the zero-shear complex viscosity. Differing particle size distributions and particle shapes for samples with differing amounts of crystalline solid have some contribution

(6) Composition of solid material: The substantive variations in viscosities of formulations with amorphous solid additives (Group B) or crystalline solid (Group F) indicate that the chemical composition of the particles affects the zero-shear complex viscosity. Differing particle size distributions and particle shape have some contribution.

The solid particles affect a reduction in complex viscosity over a range of frequencies (shear rates), not just the zero shear rate. Determination of the complex viscosity with a strain amplitude maximum of 2%, assures that stress amplitudes (˜0.01 mNm/3 Pa) are sufficiently low so as to be within the linear stress-strain regime. Although we cannot explain why solid particles affect the complex viscosity in a regime that is supposed to be dominated by intrinsic properties of the polymer alone, a 19-35% reduction in complex viscosity is real and can be used to advantage in the processing environment.

Many polymeric liquids are finished at relatively high stress and low to moderate shear rates, so consideration of the effect of solid particles on polymeric liquid viscosity as a function of stress amplitude is appropriate. For these studies, the oscillation frequency was fixed at 1 sec⁻¹, a relatively low to moderate shear rate. Referring to FIG. 4, the ease of molding a polymeric liquid is determined largely by its viscosity at stresses below and above the critical stress value 30 (σ*). Processing conditions are often set to take advantage of lower viscosity at stresses just above the critical stress value.

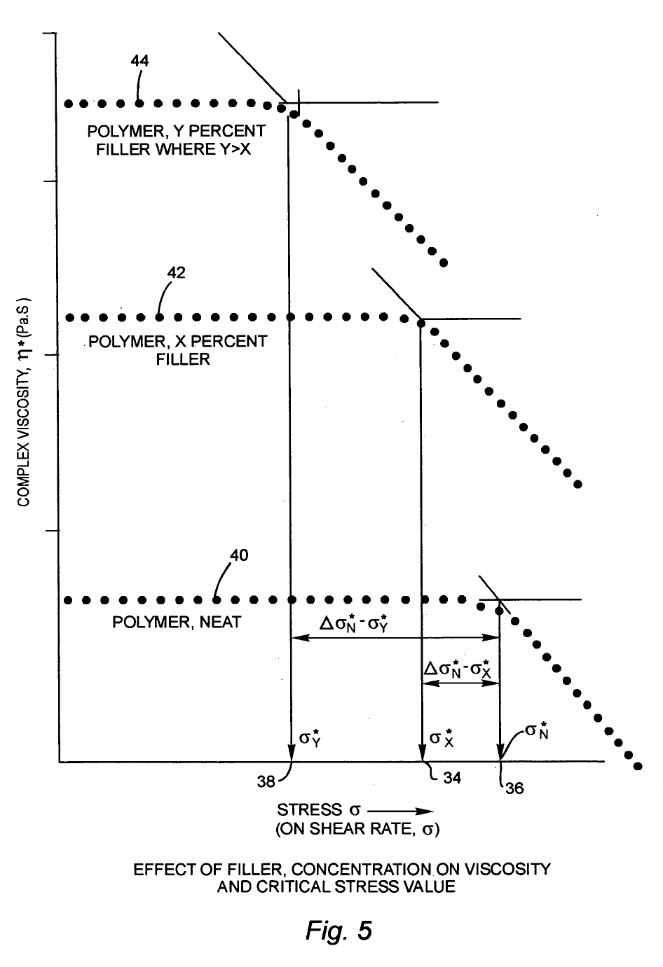

Referring to FIG. 5, a solid material in a polymeric liquid lowers the critical stress value. It is well known from study of highly filled (5-60 weight percent) polymers that the reduction in the critical stress value is proportional in a first approximation to the concentration of the solid material. This is shown by the increase in the difference (Δ) between the critical stress value 34 for x weight percent solid and the critical stress value 36 for a polymeric liquid without solid, Δσ*ₙ−σ*ₓ, as compared to the difference between the critical stress value 38 for y weight percent solid and the critical stress value 36, Δσ*ₙ−σ*_{y}, where y>x. However, the high concentration (5-60 percent) of solid in filled polymers increases the viscosity sufficiently such that the viscosity of a filled polymer formulation is greater than the unfilled formulation, as shown by curve 40 for polymer without filler, curve 42 for polymer with x percent filler, and curve 44 for polymer with y percent filler.

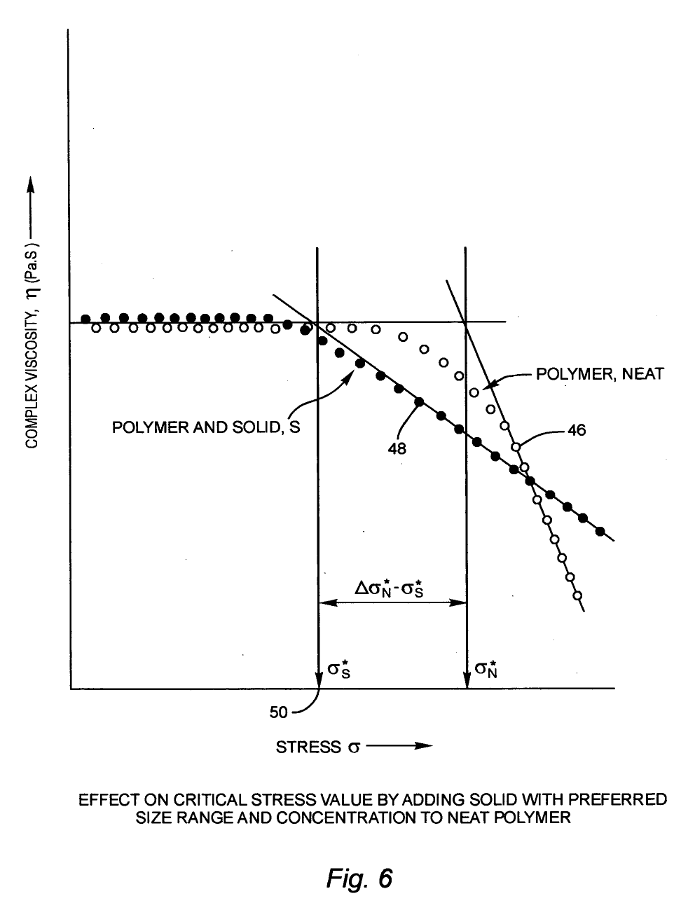

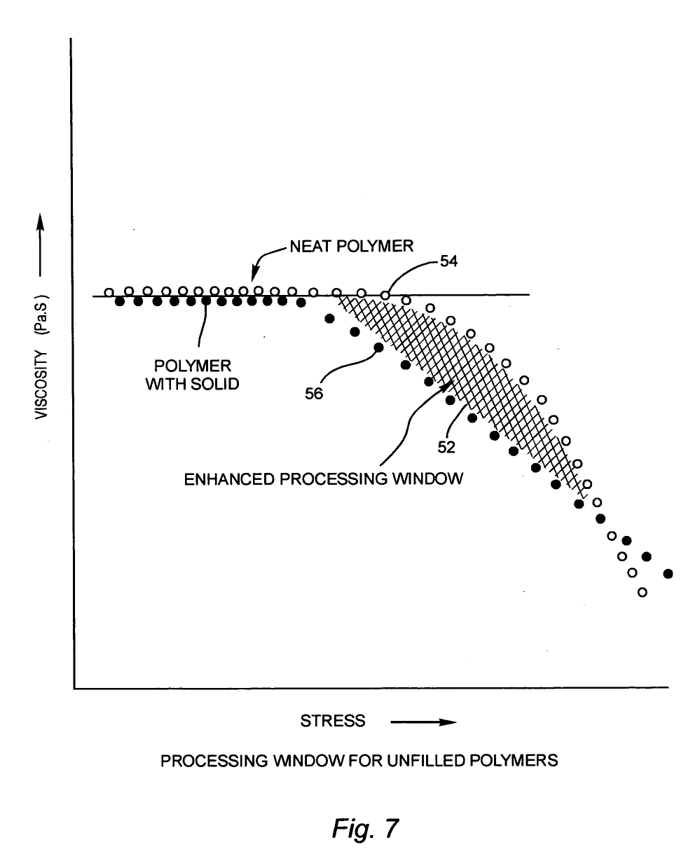

The type of viscosity decreases that result from adding a low concentration of small solid particles to a polymer as compared to viscosity increases that occur upon addition of a high concentration of solid particles (filler) are unexpected. As shown in FIG. 6 by curve 46 for neat polymer and curve 48 for polymer and solid, at concentrations of less than approximately 2 weight percent and in particle sizes less than about 75-microns diameter (equivalent spherical diameter), the viscosity of the solid-polymer formulation is not substantially increased below the critical stress value 50 of the polymer-solid (left-hand side of FIG. 6). Addition of a low concentration of an appropriate solid material decreases the critical yield stress (Δσ*ₙ−σ*ₛ; FIG. 6); however, the reduction is more than expected based on extrapolations from filled polymers. As a result, there is a stress range over which the solid-polymer formulation has a lower complex viscosity than that of NEAT polymer. This range is referred to as an enhanced processing window 52 (EPW) as shown in FIG. 7, which also shows curve 54 for NEAT polymer and curve 56 for polymer with solid. The EPW represents a range of stress conditions in which the polymer may be more readily processed due to a lower than expected viscosity for the composition and grade of polymer.

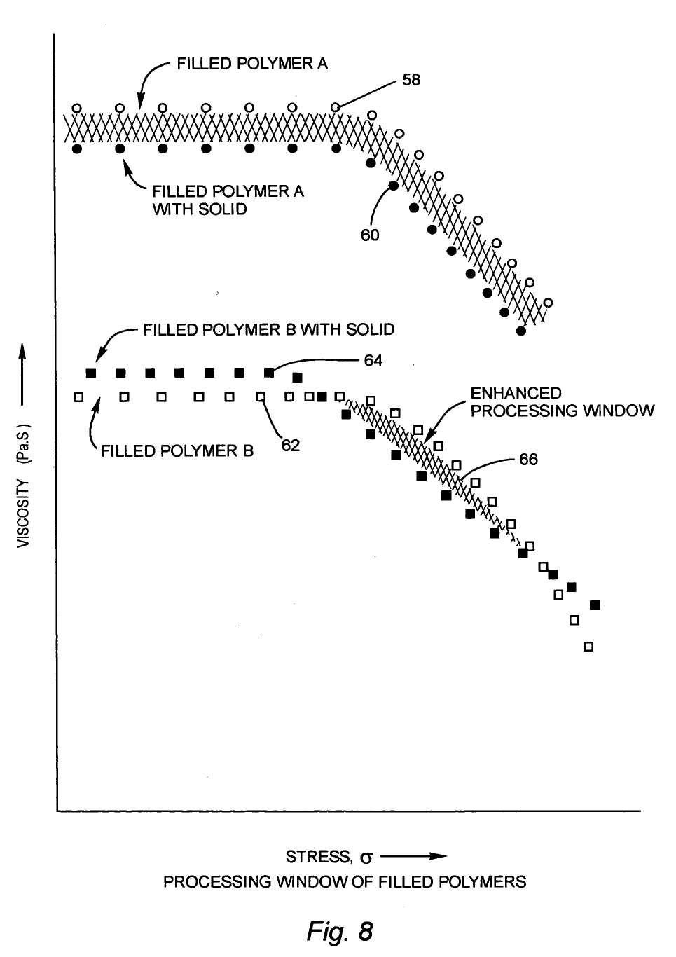

Furthermore, a viscosity decrease resulting from adding a low concentration of appropriate small solid particles to highly filled polymer systems is unexpected. Adding a low concentration of an appropriate solid material to a highly filled (5-60 percent by weight of solid additive) polymeric liquid substantially reduces the viscosity of the polymeric liquid. Two explanations are plausible and may be applicable to different filled polymeric liquid formulations. Referring to FIG. 8, one explanation is that the presence of a low concentration of appropriate solid lowers the viscosity of the polymer over all stress ranges, as shown by curve 58 for a filled polymer without solid, curve 60 for a filled polymer with solid. Alternatively, addition of a low concentration of an appropriate solid material could lower the critical stress value, much like in unfilled polymeric liquids, and create an EPW, as shown by curve 62 for a different filled polymer without solid, curve 64 for the filled polymer with solid, and enhanced processing window 66. No matter which explanation is correct, the effect of adding a small concentration of an appropriate solid is to decrease the viscosity.

The principal conclusion from laboratory-scale determination of the complex viscosity as a function of stress amplitude is that all solids, regardless of their composition, but within the preferred concentration and size range of the present system, result in a lower complex viscosity for solid-PP formulations than for NEAT PP (Table 2) for at least some temperatures and stress conditions. According to the same logic advanced for rheologic responses in the linear range, results from the detailed PP study at high stress amplitudes are applicable to other polymer compositions. Referring to PP results in Table 2, the magnitude of the complex viscosity reduction as a function of stress amplitude is dependent on a number of factors, which are listed below in decreasing order of independence from other factors:

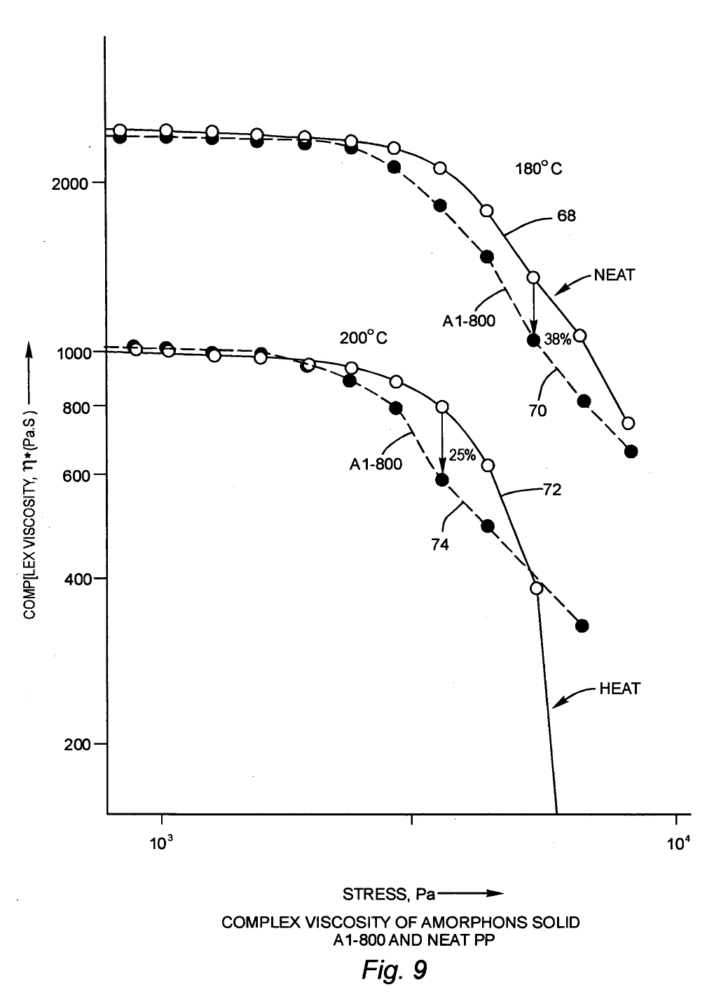

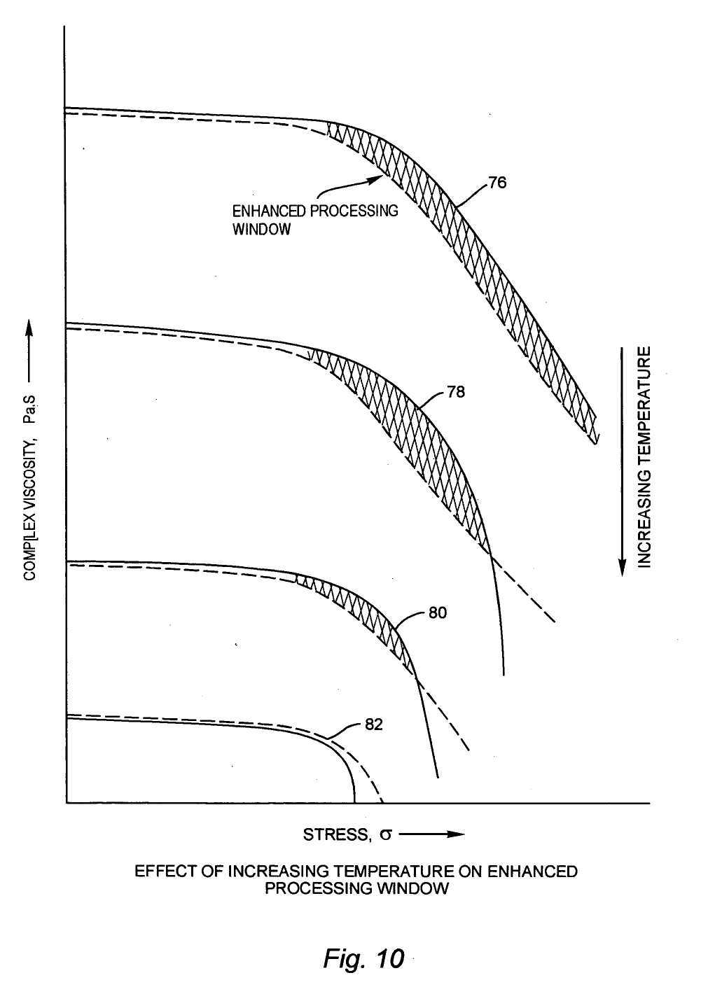

(1) Temperature: With an appropriate solid material for PP, the complex viscosity decrement increases with decreasing temperature. For example, referring to FIG. 9 showing curve 68 for NEAT PP at 180° C., curve 70 for PP with amorphous solid A1 at 180° C., curve 72 for NEAT PP at 200° C., and curve 74 for PP with amorphous solid A1 at 200° C., the complex viscosity of PP with amorphous solid A1 is 25 percent lower than NEAT PP at 200° C. but is 38 percent lower at 180° C. A corollary conclusion is that the size of the enhanced processing window decreases with increasing temperature and disappears at high temperatures, as in FIG. 10 by enhanced processing window 76 determined at a given temperature, enhanced processing window 78 determined at a higher temperature, enhanced processing window 80 determined at an even higher temperature, and enhanced processing window 82 determined at the highest temperature.

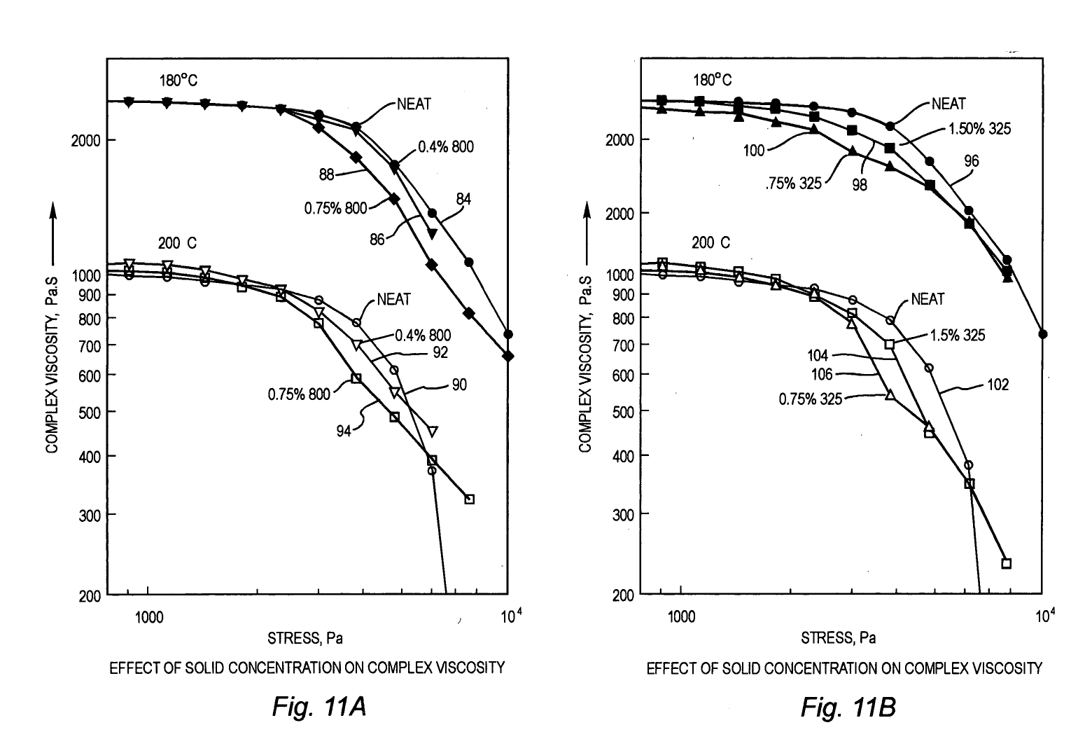

(2) Weight percent concentration: As shown in FIGS. 11A and 11B, increasing the concentration of amorphous solid A1 from 0.4 to 0.75 weight percent results in a decrease in the complex viscosity. Referring to FIG. 11A showing complex viscosity for 800 mesh solid, curve 84 is for NEAT PP at 180° C., curve 86 is for PP with solid at a concentration of 0.4%, at 180° C., curve 88 is for PP with solid at a concentration of 0.75%, at 180° C., curve 90 is for NEAT PP at 200° C., curve 92 is for PP with solid at a concentration of 0.4%, at 200° C., and curve 94 is for PP with solid at a concentration of 0.75%, at 200° C.

On the other hand, there appears to be a limit on the maximum permissible concentration because a 1.5 weight percent concentration of 325 mesh amorphous solid A1 has a higher viscosity than a formulation with 0.75 weight percent concentration. Referring to FIG. 11B showing complex viscosity for 325 mesh solid, curve 96 is for NEAT PP at 180° C., curve 98 is for PP with solid at a concentration of 1.5%, at 180° C., curve 100 is for PP with solid at a concentration of 1.5%, at 180° C., curve 102 is for NEAT PP at 200° C., curve 104 is for PP with solid at a concentration of 1.5%, at 200° C., and curve 106 is for PP with solid at a concentration of 1.5%, at 200° C. Comparable results for PE and extensive industrial-scale experience with a wide variety of polymer compositions indicate an optimal concentration of about 0.75 weight percent; solid concentrations of more than 2.0 weight percent appear to result in higher viscosity at all stress amplitudes.

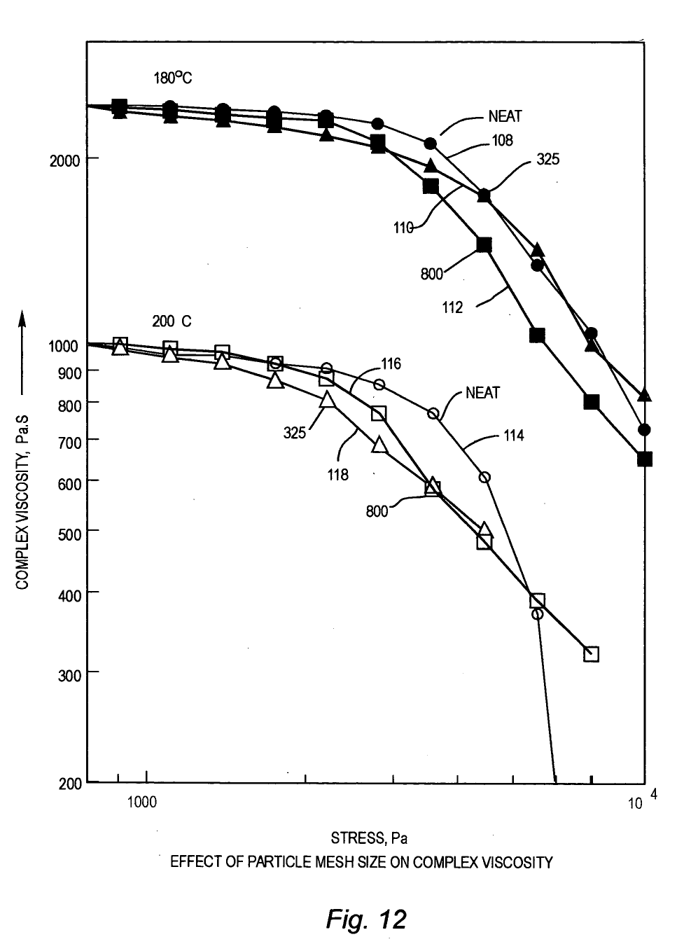

(3) Particle size range: The complex viscosity is dependent on the particle size range. As the maximum particle size range decreases from 270 mesh (55 microns) to 800 mesh (15 microns), the decrement in the complex viscosity increases. For example, 800-mesh A1 has a greater effect on viscosity than does an equal concentration of 325-mesh amorphous solid A1. This is shown in FIG. 12, where curve 108 is for NEAT PP at 180° C., curve 110 is for PP with 325-mesh solid at 180° C., curve 112 is for PP with 800-mesh solid at 180° C., curve 114 is for NEAT PP at 200° C., curve 116 is for 325-mesh solid at 200° C., and curve 118 is for 800-mesh solid at 200° C. An upper size limit of about 75 microns is probable based on decreasing viscosity-reduction effect with increasing particle size. Furthermore, the abrasive effect of particles increases rapidly with particle size and particles more than about 75 microns are abrasive to machine surfaces.

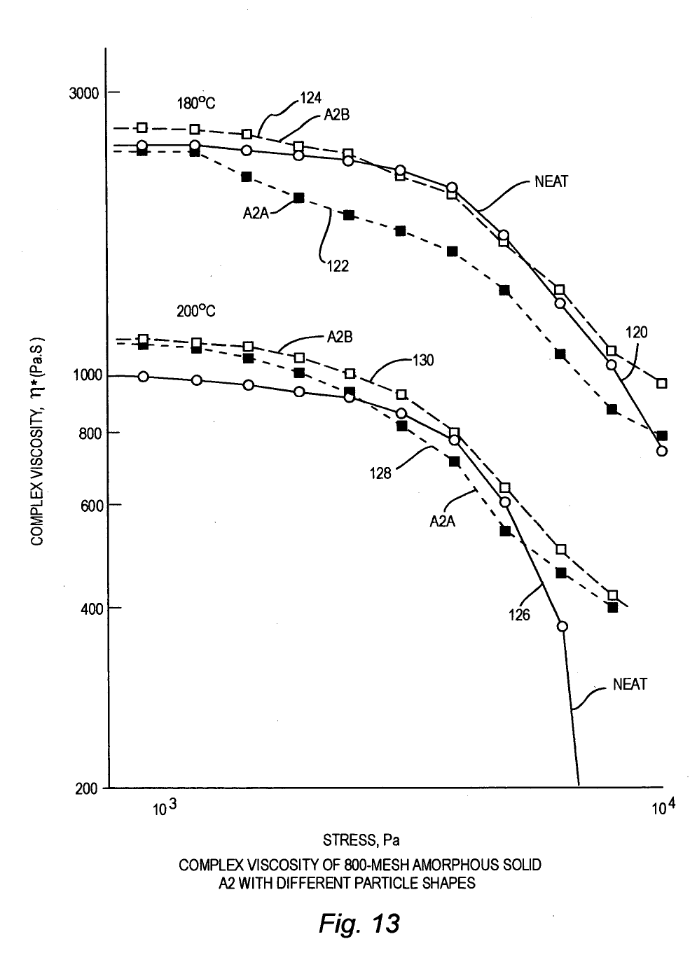

(4) Particle shape: Final milling of the solid A2 by differing technologies resulted in particles with differing shapes, particularly in aspect ratio. The particle shape and morphologic features of A2A are as prescribed and A2A particles clearly have a more substantive effect on polymer viscosity than particles of A2B that are more rounded and have less surface roughness (particularly at 180° C.). This is shown in FIG. 13, where curve 120 is for NEAT PP at 180° C., curve 122 is for PP with solid A2A at 180° C., curve 124 is for PP with solid A2B at 180° C., curve 126 is for NEAT PP at 200° C., curve 128 is for PP with solid A2A at 200° C., curve 130 is for PP with solid A2B at 200° C. Differences in particle-size distributions between the two milling technologies may have some contribution

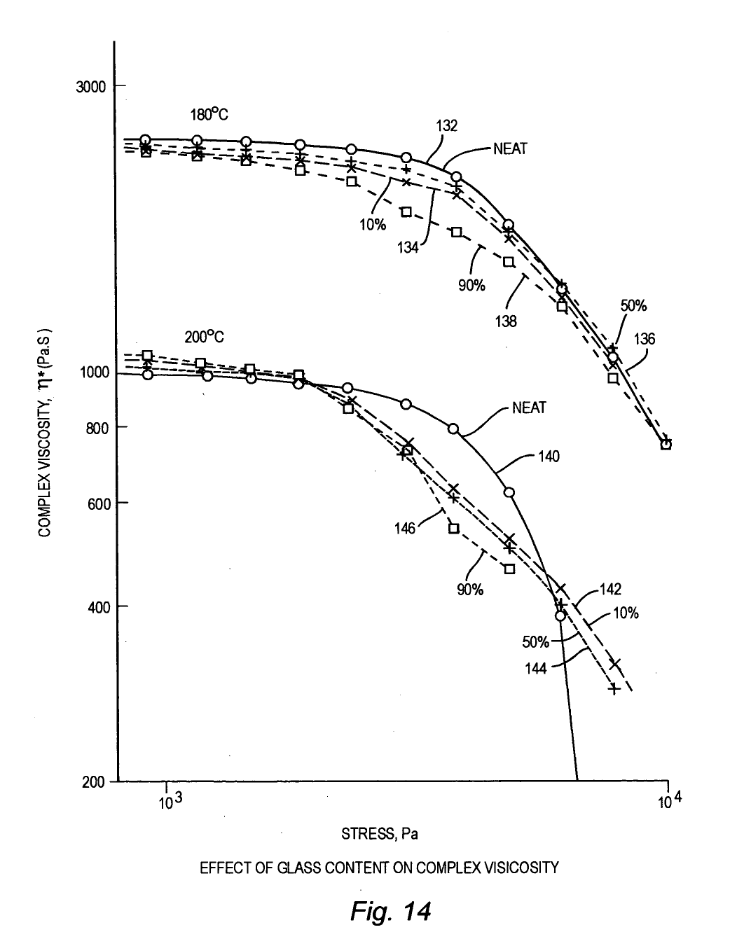

(5) Structure of solid material: The complex viscosity is dependent on the relative amounts of amorphous to crystalline phases (Group C). Although the chemical compositions of the solids are nearly identical, a solid material with high amorphous content is more effective than a solid material with high crystalline content in reducing the complex viscosity. This is shown in FIG. 14, where curve 132 is for NEAT PP at 180° C., curve 134 is for PP with solid of 10% crystalline content, at 180° C., curve 136 is for PP with solid of 50% crystalline content, at 180° C., curve 138 is for PP with solid of 90% crystalline content, at 180° C., curve 140 is for NEAT PP at 180° C., curve 142 is for PP with solid of 10% crystalline content, at 200° C., curve 144 is for PP with solid of 50% crystalline content, at 200° C., and curve 146 is for PP with solid of 90% crystalline content, at 200° C. Differing particle size distributions and particle shapes for samples with differing crystallinity have some contribution

(6) Composition of solid material: The variation in complex viscosity among amorphous (Group B) or crystalline (Group F) solid indicates that the chemical composition has an effect on the complex viscosity. Differing particle size distributions and particle shapes have substantive contributions.

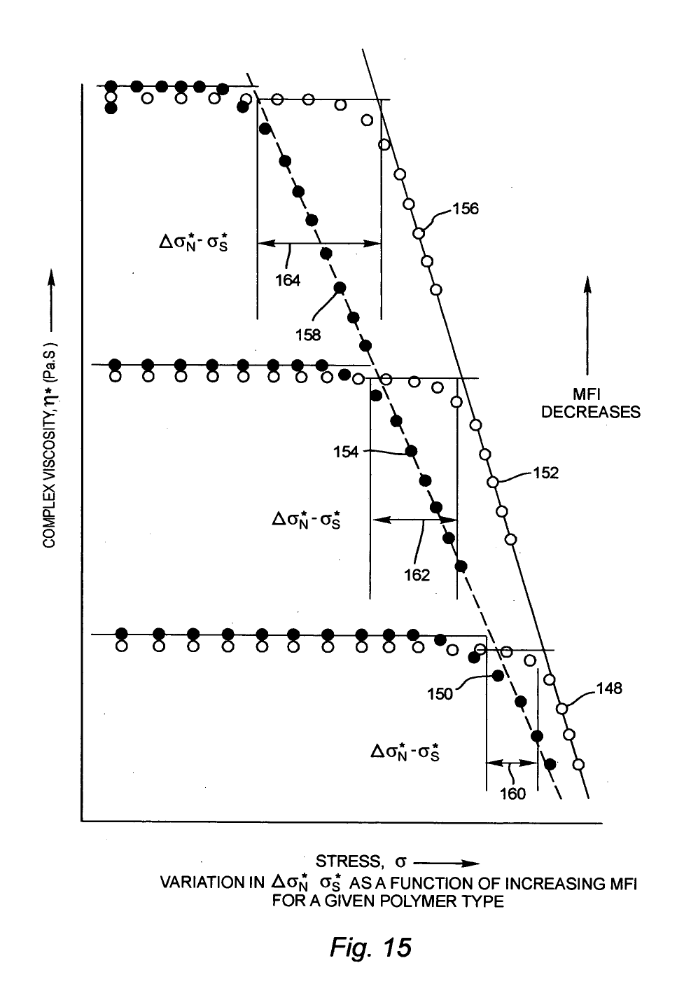

Decrements in viscosity proportional to the molecular weight distribution of the polymer are unexpected. As the molecular weight increases (melt flow decreases), the reduction in critical stress value increases (Δσ*ₙ−σ*ₛ) and the size of the EPW increases. This is shown in FIG. 15 where curves 148 and 150 are for a polymer with a given melt flow index, curves 152 and 154 are for the same polymer with a lower melt flow index, and curves 156 and 158 are for the same polymer with an even lower melt flow index, and the reduction in critical stress values is shown by critical stress values differences 160, 162 and 164. For example, PP with a melt flow of 35 (lower molecular weight) has a predictably lower apparent viscosity over a range of stresses than the same PP with a melt flow of 18 (higher molecular weight) as determined on a fully instrumented mold in an injection molding press. Addition of the solid additive to the PP formulations reduces the viscosity of both grades; however, the viscosity of the 18-melt grade is reduced more and the resulting viscosity is equivalent to that of the lower molecular weight, lower viscosity 35-melt grade. In another example, a very low melt index, blow-molding grade of PE exhibited a very large reduction in liquid viscosity upon addition of a solid. The vertically extruded parison of NEAT polymer had sufficiently high viscosity that it could be extruded, surrounded by the mold and blown before sagging. Upon introduction of the solid, the parison had such a low viscosity, it fell to the floor before the mold could close.

Referring to FIG. 1, step 10 is directed to the usefulness of the system and optimization of the process on industrial-scale equipment. Use of the system has four stated objectives: (1) improved processing efficiency of polymeric liquids, (2) improved performance of functional additives, (3) improved physical/mechanical properties of the finished polymer, and (4) purging of contaminants from processing equipment. The usefulness of the system to achieving the four objectives is now considered. Cited examples are primarily based on PP and PE polymer compositions; however, the results for these two polymeric compositions are presumed to be applicable to a wide variety of polymer compositions. The system is remarkable because it is applicable to an exceptionally broad range of polymeric liquid compositions and it is applicable to NEAT and filled polymer compositions.

Improved Processing Efficiency: as used herein, processing efficiency is the time required to make the part as well as the number of quality parts compared to total number of parts made. The system is very robust because the polymeric liquid viscosity can be reduced over a wide range of stress and strain rates that correspond to a wide variety of polymer finishing technologies.

In low stress/low shear rate environments (e.g., thermoforming, slush, compression), a viscosity reduction allows for substantial improvements in polymer processing. For example, vacuum-forming of sheet goods is greatly improved because a higher elastic modulus for a solid-polymer formulation prevents premature sagging of the sheet into the cavity (with consequent defects), yet when vacuum is applied to draw the polymer sheet into the mold cavity, a lower viscosity at relatively low stress allows for more accurate molding and a more uniform wall thickness. As a result, fewer parts are rejected because of uneven wall thickness, warp or internal stress-induced cracking. Even in molding environments such as injection that operate dominantly at higher stress/shear rates, lower stress/slower shear rate environments exist. A reduced viscosity of the polymeric liquid in these regions improves molding efficiency.

In high stress/moderate shear rate environments, operating a press within the stress range of the enhanced processing window improves polymer processing. For example, injection molding may result in a number of rejects due to incomplete mold fill; however, with a reduced viscosity the mold invariably fills. A corollary observation is that the dimensional stability of parts typically improves with a solid-polymer formulation as compared to NEAT polymer, presumably because of more uniform filling of the mold (a particularly difficult problem with highly filled polymers). An increase in polymer viscosity reduction with increasing molecular weight may be specific to a high stress environment. Nevertheless it is important in mitigating lot-to-lot viscosity variations or allowing efficient molding of high molecular weight polymers. As an added benefit, a reduced viscosity corresponds with less force required to mold the part and the equipment sustains reduce wear and tear.

In all molding environments, a lower viscosity allows for processing at reduced temperatures (particularly for solid-polymer formulations that have a greater viscosity decrement at lower temperatures), which reduces the cooling time for thermoplastics, reduces polymer or additive degradation and may reduce energy costs per article.

Improved performance of functional additives: A persistent problem in polymer processing is achieving dispersion and uniform distribution of additives such as pigments, impact modifiers, flame retardants, antioxidants and other solid, chemical, natural and synthesized additives, including nanocomposite materials. When these additives are not fully dispersed and distributed, they are less effective. To counteract their ineffectiveness, the concentration of the additives is increased to achieve the desired effect.

Poor dispersion and distribution of additives, assuming proper compounding, can originate for many reasons. For example, polar additives may be chemically incompatible with a non-polar polymer. The polar additives tend to agglomerate with one another thus reducing their functionality rather achieving their full functionality when evenly dispersed and distributed throughout the polymer. As another example, impact modifiers, which are often composed of an elastomer, are most effective when elastomeric particles are small and have a large contact surface area with the host polymer. Large aggregates of elastomer are less effective because the volume increases proportionally to the radius cubed whereas the surface area increases proportionally to the radius squared. For an impact modifier to be most effective, the surface area is preferably maximized for the volume of added elastomer. Obviously, formation of large diameter aggregates does not maximize the surface area for a given volume.

Numerous field and laboratory studies have concluded that addition of particles as specified by this process can greatly increase the performance of functional additives such as organic and inorganic pigments, impact modifiers, flame retardants, antioxidants, UV stabilizers, antistatic agents, thermal stabilizers, EMI and EMF and ESD shielding agents, antifogging agents, conductive agents, dielectric agents, biocides/antimicrobial agents, blowing agents, composite materials, coupling and wetting agents, cross-linking agents, curing agents, degradation agents, dyes, foaming agents, plasticizers, anti-blocking agents, special effects agents, PVC stabilizers, surfactants, thermally conductive additives, and UV curable additives.

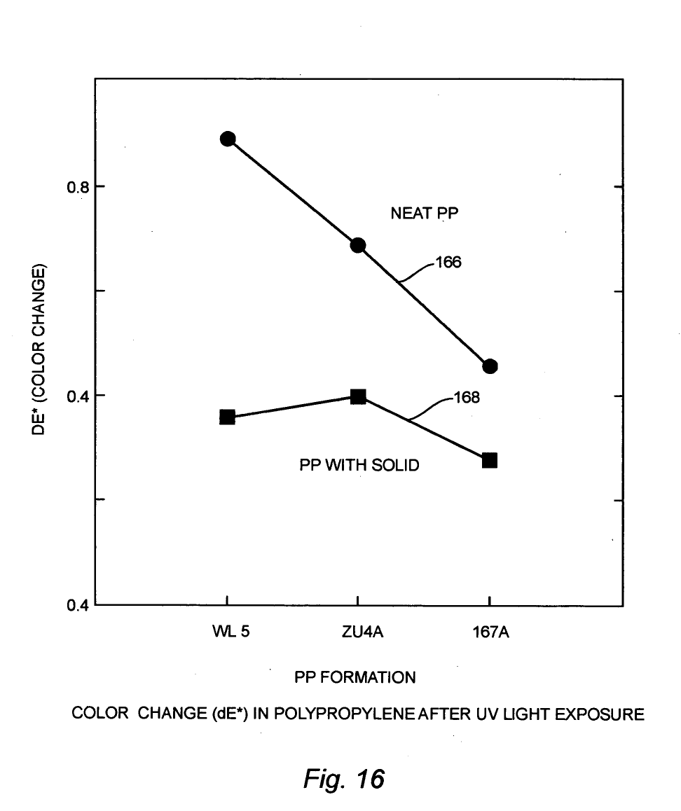

For example, different polypropylene formulations are more resistant to UV light degradation by adding a solid material as prescribed by this process. After standard UV light exposures, the change in finished polymer color (dE*) is approximately one-half for formulations with the solid additive as compared to the polymer without a solid additive, as shown in FIG. 16 by curve 166 for NEAT PP and curve 168 for PP with solid. This difference indicates that the UV stabilizer is dispersed better and is more effective in protecting the formulation with the solid than that without the solid. Tests of the solid alone demonstrated that the solid without a UV stabilizer provided no additional UV protection. In another example, addition of a solid to a copolymer with an impact modifier additive increased the Gardner impact strength by 40 percent (Table 4). The large increase in impact strength is not attributed to the solid, because polymers without impact modifiers do not show increased impact strengths upon addition of a solid. Other field studies of both injection and extrusion molding have indicated that addition of a solid as prescribed in this process reduces the amount of other additives such as blowing agents by as much as 50 percent with no reduction in quality of the foamed polymer.

It is postulated that addition of a solid material as prescribed in this process modifies the viscosity of the polymer in such a way as to improve dispersion and distribution of other additives. At very high stresses, the complex viscosity of solid-bearing polymer is actually higher than NEAT polymer (far right, FIG. 9). High shear rates (high frequency oscillations) also tend to increase viscosity at high stress amplitudes. Very high stresses and shear rates occur in the mixing zone and around the flight tips on screws in injection molding and extruding equipment where much of the dispersion and distribution of additives takes place. This higher viscosity aids in breaking up agglomerates of additives and dispersing them in the polymeric liquid, much like a baker kneads viscous bread dough to break up flour lumps. In other parts of processing equipment, lower polymeric liquid viscosity can result in better distribution of the dispersed additives. The presence of small solid particles prevents re-agglomeration of the additives, thus improving the stability of dispersion and distribution. Notably increased dispersion and distribution of dissimilar polymer types in recycled plastics are also a result of higher viscosity and mixing in the high stress regions of processing equipment.

Improved physical/mechanical properties of finished polymer: For thermoplastics, it is well known that the processing temperature of a polymer affects the mechanical properties of the finished polymer (e.g., impact strength, flexural modulus, tensile modulus, elongation, heat deflection temperature [HDT]). A general rule is, the lower the final processing temperature, the stronger the finished polymer. The process as practiced can result in improved physical/mechanical properties of the finished polymer. If the finishing process is within the EPW, the viscosity of the solid-bearing polymeric liquid is less than that of the polymer alone. Processing temperatures can be reduced with relatively little change or only modest increases in polymeric liquid viscosity. As a result of the lower processing temperature, the mechanical properties should increase. In one experiment, PP was formulated with solid particles of differing size range and concentration. The two formulations were test molded at two different temperatures—200° C., which is the minimum recommended processing temperature for NEAT PP, and 180° C. Although some improvement in impact strength and HDT appears to be attributed to solid particles, substantial increases in impact strength and HDT were noted for the samples molded a the lower temperature (Table 5). A similar result was obtained for an impact-modified polypropylene copolymer. Articles were being molded at a high temperature so as to achieve rapid and consistent production. Addition of a solid allowed for further productivity increases but 3 out of 10 parts failed an extreme-cold (−30° C.) impact test. Lowering the molding temperature by only 9° C. resulted in all 10 parts passing the extreme-cold impact test. In another test, PE with solid A1 additive was molded at temperatures about 15° C. below those normally recommended. The finished polyethylene had a flexural modulus 25-30 percent higher than the NEAT polyethylene and the impact strength was about the same. It is expected that similar increases in mechanical properties such as impact strength, flexural modulus and HDT will occur for other semicrystalline polymers whereas amorphous polymers may have increased flexural and tensile properties as a result of lower processing temperature.

Improved purging of processing equipment: Polymer formulations with a low concentration of small particles improve the purging of contaminants from processing equipment. Processing of polymers invariably results in minor degradation (often charring) of the polymer and plating of the degradation products onto wetted surfaces. Additives, particularly ones that are incompatible with the polymer, may also plate out onto wetted surfaces. As these build up they can reduce the efficiency of polymer processing or aggregates of degraded polymer or additives flake off, resulting in cosmetic defects in the finished article.

Numerous field trials have indicated that the process as practiced purges processing equipment of contaminants. For example, an extruder was cleaned using a commercial purging agent. Presumably the commercial purging agent cleaned the extruder; however, solid-polymer formulations made in the extruder immediately after purging had numerous flakes of degraded polymer throughout. As the compounding continued with other solid-polymer formulations, the number of contaminant flakes decreased and disappeared after several formulations. In another example, an injection-molding machine had been in continuous production for four days, making 5-gallon PE pails with a white TiO₂ pigment. Upon introduction of the solid, the pails had streaks of yellow, blue and black pigment from production runs days before white pail production. In addition, streaks of highly concentrated TiO₂ pigment were evident in the polymer. After about two hours of production, no contamination was evident and the pails had a uniform white color. An obvious advantage to continuous purging is a reduction in maintenance required to provide a clean processing environment.

It is believed that the current process is responsible for purging of contaminants. Contaminants tend to form in high-stress and high shear-rate regions of processing equipment because of stress-induced degradation of long-polymer chains or thermally induced degradation of polymer chains or additives. In these regions where contaminants are accumulating, the viscosity of solid-polymer formulations is higher than that of the equivalent NEAT polymer. The higher viscosity of the solid-polymer formulation results in increased shear stress on the contaminants, thus dislodging them from equipment surfaces. As is usual for solid-polymer formulations, processing temperatures can be reduced, thus reducing the rate of thermal degradation of polymer or additives.

Optimization of polymer processing consists of two interrelated stages: (1) determination of the best solid-polymer formulation to achieve stated objectives and (2) optimization of processing conditions.

Laboratory-scale determination of solid-polymer viscoelastic properties can provide general guidelines to the best formulation to achieve a particular objective. However, laboratory-scale studies are simple as compared to highly variable and complex stress and strain-rate environments in typical processing equipment. As suggested in FIG. 1, step 6, laboratory-scale evaluation of solid-polymer formulations should provide a general idea of the best potential formulations. Use of narrow size ranges is very effective for determining the relative effect of each size range; however, production of narrow size ranges is not cost effective for most applications. A more practical conclusion to be drawn from the narrow size range study is the upper size limit to produced in the final milling. These formulations as well as variants of these formulations (e.g. particle size range, solid concentration, polymer grade) need to be prepared and processed on industrial equipment that will be used to make finished articles. By determining the optimal processing characteristics for each formulation, it will be easy to decide which solid-polymer formulation will achieve the best combination of stated objectives.

Processing of polymeric liquids to finished articles utilizes an extremely diverse array of equipment operating at widely varying temperature, stresses and shear rates. The prescribed system can readily be adapted to a wide range of processing equipment and polymer compositions; however, it is not feasible to describe each combination of processing equipment and polymer type. Injection molding of a thermoplastic is described as a representative example. Injection molding is the most complex molding process and changes to operating parameters required to take full advantage of the effects of solid particles on thermoplastic polymeric liquids are the least intuitive. A second example, extrusion molding, is presented to demonstrate the adaptability of the system to different molding environments. These two examples indicate that process optimizations can be done for most any combination of processing equipment and polymer type.

Process optimization as used for injection molding is the determination of process parameters that result in the most time-efficient production of high-quality articles. Contrary to conventional wisdom, the system as prescribed, typically requires a reduction in temperature and stress in order to achieve maximum process optimization.

Temperature management includes obvious thermal energy sources such as barrel, nozzle and hot runner heaters as well as less obvious frictional heat sources such as screw-recovery speed and injection speed. As demonstrated in DMA analyses, reduction in polymer viscosity due to the effect of particulate solids is inversely related to temperature. Although lowering of the temperature increases the viscosity of the NEAT polymer, the viscosity decrement due to solid particles increases with decreasing temperature. For each processing environment, there is an optimal tradeoff between increased polymer viscosity and larger decrement in polymer viscosity due to solid particles. Typically, polyolefin and nylon processing can be optimized at temperatures of up to 20° C. below the lowest recommended processing temperature whereas amorphous polymers can be optimally processed at temperatures 10-15° C. below the middle range of processing temperatures.

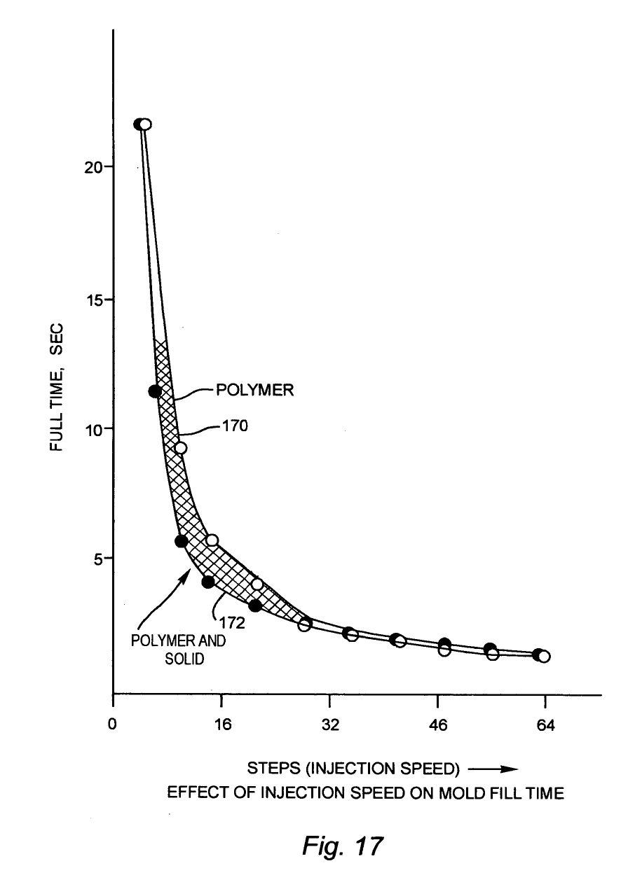

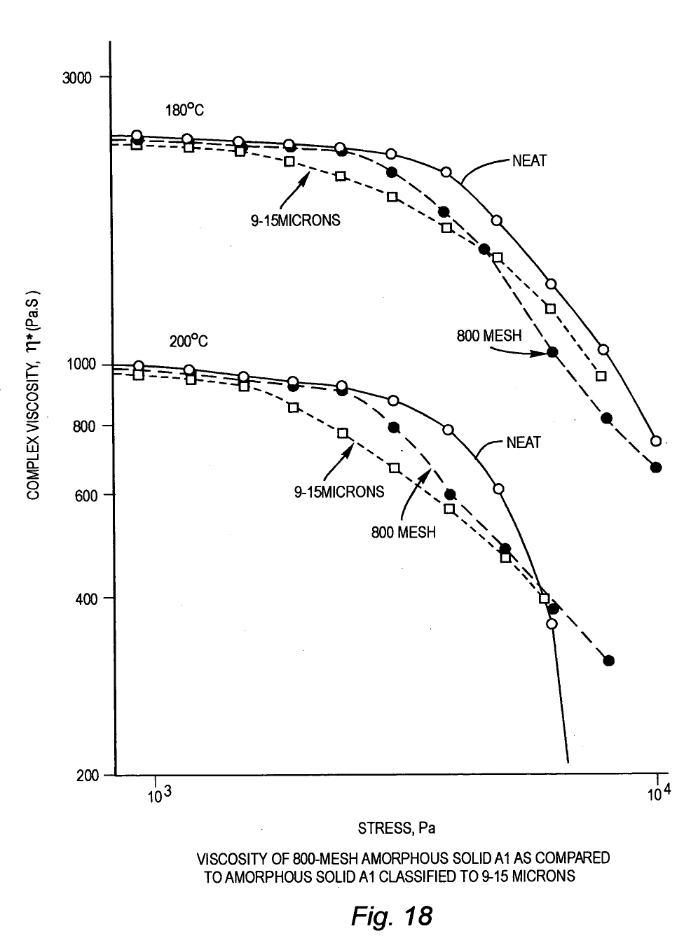

The most significant aspect of stress management is to achieve processing conditions that assure press operation within the stress range of the enhanced processing window. If the stress, as determined by injection speed, is too low or too high, the viscosity of the polymer with solid material will be either the same as or higher than that of the NEAT polymer as shown in FIG. 17 where curve 170 is for polymer without solid and curve 172 is for polymer with solid. Within a stress range, the apparent viscosity (proxied by the fill time) will be substantially lower than that of the NEAT polymer. Even though the apparent viscosity reduction related to the solid particles appears to increase with decreasing injection speed, the optimal injection speed is one that ensures a consistent part weight that is the same or up to 1% higher than the part weight for the NEAT polymer formulation.

Typically, determination of optimal processing parameters is an iterative process for which a number of interacting process parameters are altered and balanced to achieve an optimized enhanced processing window and, hence, optimal processing conditions. General guidelines are presented, but specific directions cannot be offered because each combination of press, mold and polymer will require adjustments that are specific to the particular combination.

The processing parameters are optimized for NEAT polymer prior to introduction of the solid material. The final step before introduction of the solid material is to lower operating temperatures until a short shot (incomplete mold fill) results or the part weight decreases. At this point, the solid material is introduced into the press. One or more of the following responses should be observed (assuming that the equipment is not controlled by software that prevents operating parameter changes): (1) decrease of 10-20% in pressure at transfer, (2) mold fill time decrease, or (3) flash along the seam between mold parts.

The remaining steps towards optimizing the process are iterative in that change in one process parameter may necessitate changes in another. Experienced equipment operators typically achieve process optimization. If major flash occurs upon introduction of the solid material, the shot size is usually adjusted to minimize flashing. The temperature is gradually reduced, allowing for stabilization after each decrease. The backpressure on the screw and screw speed are reduced so that recovery remains shorter than the cooling time, the polymer is fully plasticized and the part weight remains constant. Simultaneously, the cooling time can be reduced, usually while maintaining a demolding (ejection of part from mold core) part temperature that is comparable to the part temperature for the optimized process or until there is polymer delamination or separation at corners, edges or intersections. In some instances, pack and hold time, or transfer position may be adjusted to optimize the process and maintain part weight. The iterative process is continued until no further process improvement can be achieved.

The overall effect of optimizing the process parameters is to increase productivity, chiefly by reducing the cure (cooling) time, which is typically the longest step in the overall processing cycle. Productivity increases may result also from a faster injection speed or less pack and hold time, but these are typically small as compared to the cure-time reduction.

For extrusion molding, the optimization process is considerably less complex. For example, a 100-mm twin-screw extruder was optimized for production of 2-inch diameter PVC pipe. Solid additive in a carrier polymer was dry mixed into the feed. The extrusion rate increased 11 percent as soon as the solid-polymer formulation displaced the NEAT PVC. Once the process stabilized, barrel temperatures were decreased in two-10° F. increments, the feed rate was increased and the take-up rate of extruder pipe was increased. At the optimal processing parameters, the productivity of the extrusion line increased 61 percent and the amperage draw per lineal foot of pipe decreased from 3.3 to 2.2 amps.

Referring to FIG. 1, the final step 11, is to deliberately modify the process to selectively enhance one or more of the stated objectives: (1) polymeric liquid viscosity at very low shear rates/low stress or high stress/moderate shear rates, (2) dispersion and distribution additives in the polymeric matrix, and (3) improvement of physical/mechanical properties of the finished polymer. Although the given examples are for solid-PP formulations, the process for deliberately modifying solid-polymer formulations can be used for any solid-polymer formulation. The primary focus presented is on particle size and solid concentration; however, other variables such as but not limited to solid composition or particle shape can be included in the test matrix and may be relevant to enhancement of one or more objectives.

Polymeric liquid viscosity: We postulated that polymeric liquid viscosity changes are believed to be a result of different mechanisms or combination of mechanisms at a low stress/low shear rate and than at a high stress/moderate shear rate. Whether this hypothesis is valid or not, it is clear that changes in solid particle characteristics to deliberately modify polymeric liquid viscosity at low stress/low shear rates are different than those at high stress/moderate shear rates.

In a low stress/low shear rate environment particle-size distribution appears to be most effective at lowering the viscosity of a solid-PP formulation. Narrow particle size ranges of 5-9 or 9-15 microns result in the lowest recorded viscosities for PP (Table 2). Furthermore, 325-mesh A1 is reasonably effective in lowering viscosity at both low and high temperatures-an effect that is clearly absent in the high stress environment. The solid concentration also appears to have a substantial role. A concentration of 0.4 weight percent of 800-mesh A1 has a lower viscosity than a 0.75 weight percent concentration. This indicates that lower concentration of narrow particle sizes such as 5-9 or 9-15 microns will have an even lower viscosity than a 0.75 weight percent concentration, an effect absent from the high stress environment.

In a high stress/moderate shear rate environment, the only recognized method to lower the complex viscosity of a solid-PP formulation is to use a select particle size range. Solid A1 with a particle size range of 9-15 microns very substantially reduces the critical shear value and affords a substantially larger EPW at high temperature than solid A1 with a wide particle size range of up to 15 microns.

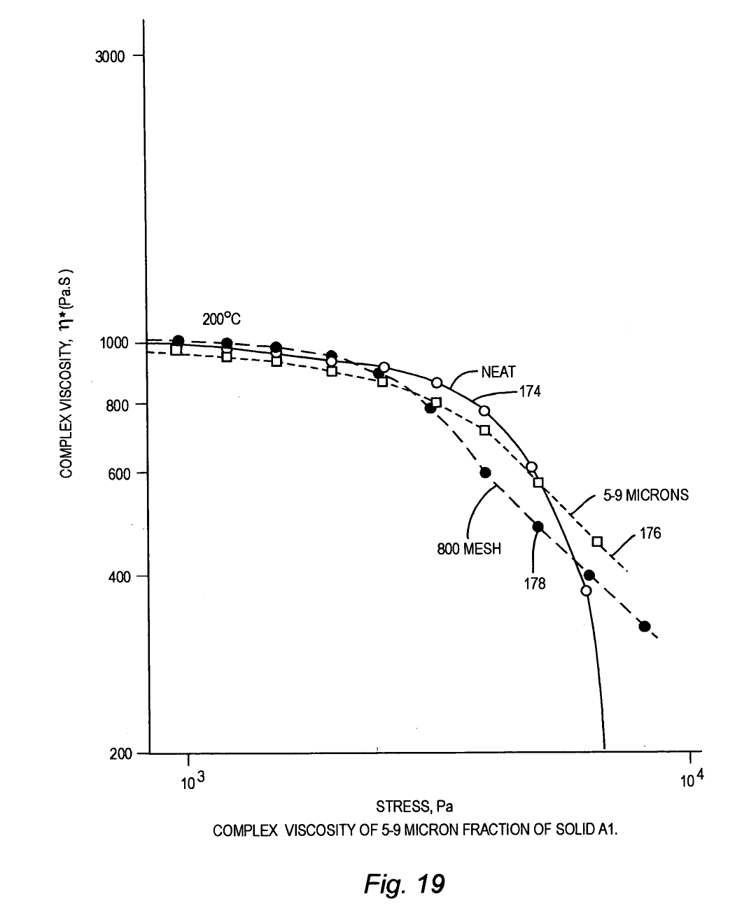

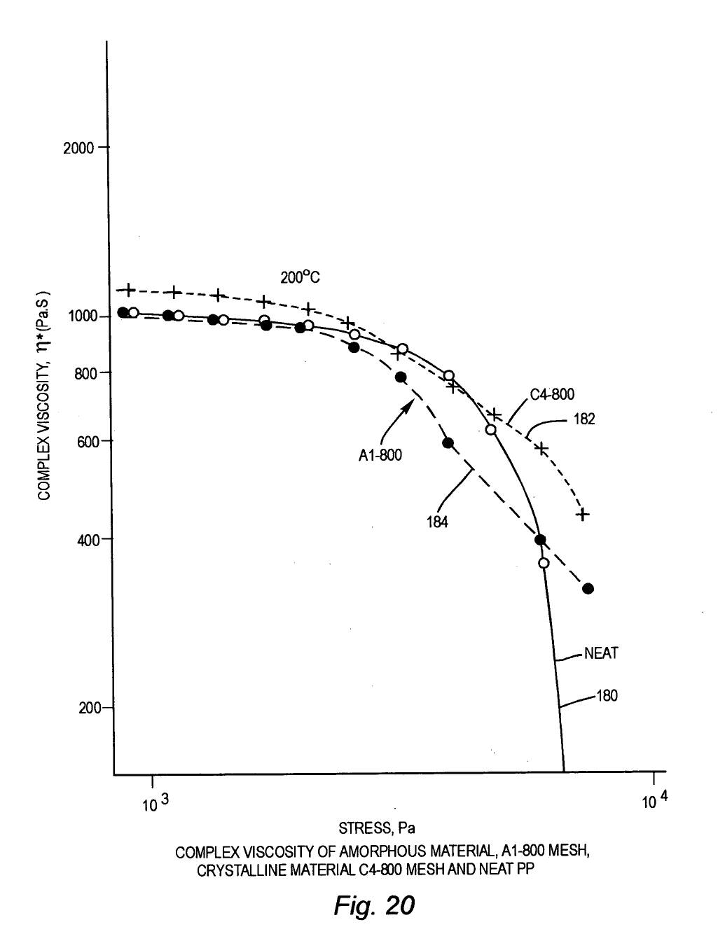

Additive Dispersion and Distribution: It has been postulated and partially substantiated in industrial applications that the dispersion and distribution of additives is improved by an increase in polymer viscosity in high-stress regions of processing equipment. As shown in FIG. 11, addition of 0.4 weight percent of 800-mesh A1 does not create a substantive EPW, but increases polymer viscosity at high stress. In one example, an injection molder experienced streaky red coloration of a polyolefin, suggesting poor dispersion of the pigment. Addition of 0.3 weight percent of solid A1 to the formulation resulted in an evenly pigmented product, strongly supporting the postulate that increased viscosity in the high-stress regions of the processing equipment dispersed and distributed the solid pigment. At least three other techniques may be used to improve dispersion and distribution. Selected size fractions (2-7 microns) of a solid material such as A1 affords little in the way of lowered viscosity but increases the complex viscosity at high stress, which presumably would increase dispersion and distribution of an additive. This is shown in FIG. 19 where curve 174 is for NEAT polymer, curve 176 is for polymer with solid of 5-9 microns, and curve 178 is for polymer with 800-mesh solid. An alternative technique would be to select another solid, for example C4, which provides almost no enhanced processing window, but substantially increases the complex viscosity at very high stress. This is shown in FIG. 20 where curve 180 is for NEAT polymer, curve 182 is for polymer with solid C4, and curve 184 is for polymer with solid A1. A third method to increase dispersion is to use a different final milling method. The method used to create A2B does not create much of an enhanced processing window; however, it does result in substantially higher complex viscosity at high stress and presumably better dispersion of an additive.

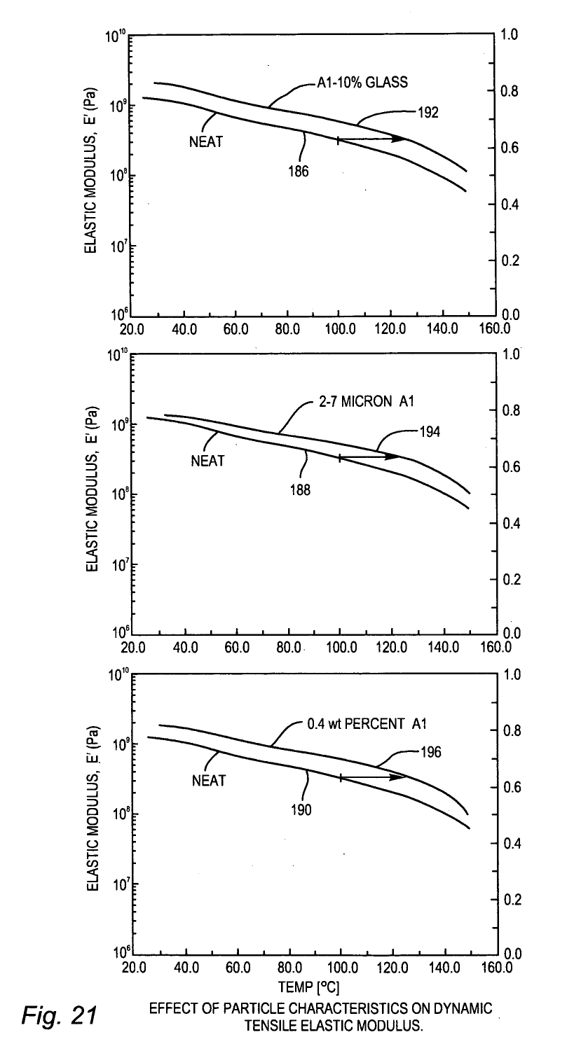

Physical/Mechanical properties of finished polymer: Although reduced melt temperatures can contribute to improved physical/mechanical properties, the magnitude of improvement indicates that the particles themselves are contributing significantly. Based on this hypothesis, then deliberately changing the particle size, concentration, and composition as compared to optimal particle characteristics required to improve polymeric liquid processability should result in physical/mechanical property improvements. This hypothesis has been substantiated. For example, the dynamic tensile elastic modulus can be improved substantially as compared to NEAT polymer by adding solid A1 classified to a particle size range of 2-7 microns, adding a solid A1 that has only 10 percent glass, or by adding only 0.4 weight percent of 800-mesh A1 to a polymer. This is shown in FIG. 21 where curves 186, 188 and 190 are for NEAT polymer, and curve 192 is for polymer with A1 which has 10% glass, 194 is for polymer with A1 with particle size range of 2-7 microns, and curve 196 is for polymer with 0.4 weight percent of 800-mesh A1. None of these formulations are optimal for lowering polymeric liquid viscosity, but they are effective in increasing the dynamic tensile elastic modulus. For each formulation, the elastic modulus is increased such that an equivalent elastic modulus is achieved at approximately 20° C. higher temperature than for the NEAT polymer. The increase in elastic modulus suggests that the polymer will have greater creep resistance and/or improved heat deflection temperatures-both essential attributes for thermoplastic applications.

Improvements in physical/mechanical properties of thermoset such as elastomers and epoxies are also expected when a solid material as practiced in this process is added. Although only limited data have been acquired for a thermoset urethane, the modulus and tensile strength are increased by addition of an appropriate concentration of a solid material (Table 6). It is anticipated that the physical/mechanical properties of this as well as other thermosets can be manipulated by deliberately changing particle concentration, size and composition as for thermoplastics.

1. A composition comprising:
(a) a polymeric liquid; and
(b) a viscosity modifier comprising a solid material active in lowering the viscosity of the polymeric liquid, the solid material being at a concentration of less than about 2% by weight of the composition and with particle sizes less than about 75 microns equivalent spherical diameter and an amorphous content of greater than about 93% by weight.

2. A composition comprising:
a) a polymeric liquid selected from the group consisting of a thermoset polymeric liquid and a thermoplastic vulcanizate polymeric liquid; and
(b) a viscosity modifier including a solid material active in lowering the viscosity of the polymeric liquid, the solid material being at a concentration of less than about 2% by weight of the composition and with particle sizes less than about 75 microns equivalent spherical diameter.

3. The composition of claim 2 wherein the solid material lowers the viscosity of the polymeric liquid at stress amplitudes and strain rates where a linear relation exists between stress amplitude and strain rate.

4. The composition of claim 2 wherein the solid material lowers the viscosity of the polymeric liquid at stress amplitudes and strain rates approaching and exceeding the critical stress value of the polymeric liquid.

5. The composition of claim 2, the solid material comprising a preparation of a crystalline carbonate, a crystalline phosphate, a magnesium alumino silicate, a magnesium silicate, a metal oxide or a crystalline silicone dioxide.

6. The composition of claim 2, the solid material having an amorphous content of greater than about 85% by weight.

7. The composition of claim 1 or 6, the solid material having a crystalline content of less than about 1% by weight.

8. The composition of claim 1 or 2, the solid material comprising a preparation of aluminosilicate.

9. The composition of claim 8, the solid material having a cristobalitte content of less than about 1% by weight.

10. The composition of claim 8, the solid material comprising a preparation of milled naturally occurring aluminosilicate.

11. The composition of claim 1 or 2, the solid material having particles of at least about 50% by weight of a Mohs hardness value ranging from about 3 to 6.

12. The composition of claim 1 or 2, the solid material having particles with a non-symmetrical shape.

13. The composition of claim 1 or 2, the solid material having particles with an aspect ratio of at least about 0.6.

14. The composition of claim 1 or 2, the solid material having particles with uneven surface morphology.

15. The composition of claim 1 or 2, the polymeric liquid including at least one recycled polymer.

16. A finished polymer of the composition of claim 1 or 2.

17. An article comprising the composition of claim 1 or 2.

18. A composition comprising:
(a) a polymeric liquid; and
(b) a viscosity modifier comprising a solid material active in lowering the viscosity of the polymeric liquid, the solid material at a concentration of less than about 2% by weight of the composition and with particle sizes less than about 75 microns equivalent spherical diameter, but excluding a viscosity modifier consisting of a preparation of naturally occurring aluminosilicate.

19. The composition of claim 18 wherein the solid material lowers the viscosity of the polymeric liquid at stress amplitudes and strain rates where a linear relation exists between stress amplitude and strain rate.

20. The composition of claim 18 wherein the solid material lowers the viscosity of the polymeric liquid at stress amplitudes and strain rates approaching and exceeding the critical stress value of the polymeric liquid.

21. The composition of claim 18 wherein the polymeric liquid comprises at least one recycled polymer.

22. The composition of claim 18 wherein the solid material comprises a preparation of a crystalline carbonate, a crystalline phosphate, a magnesium alumino silicate, a magnesium silicate, a metal oxide or a crystalline silicone dioxide.

23. The composition of claim 18 wherein at least about 50% by weight of the solid material has a Mohs hardness value ranging from about 3 to 6.

24. The composition of claim 18 wherein particles of the solid material have a non-symmetrical shape.

25. The composition of claim 18 wherein particles of the solid material have an aspect ratio of at least about 0.6.

26. The composition of claim 18 wherein particles of the solid material have uneven surface morphology.

27. A method of lowering the viscosity of a polymeric liquid, the method comprising dispersing and distributing throughout a polymeric liquid a viscosity modifier, the viscosity modifier comprising a solid material active in lowering the viscosity of the polymeric liquid, the solid material at a concentration of less than about 2% by weight of the composition and with particle sizes less than about 75 microns equivalent spherical diameter and an amorphous content of greater than about 93% by weight.

28. A method of lowering the viscosity of a polymeric liquid, the method comprising:
(a) providing a polymeric liquid selected from the group consisting of a thermoset polymeric liquid and a thermoplastic vulcanizate polymeric liquid; and
(b) dispersing and distributing throughout the polymeric liquid a viscosity modifier, the viscosity modifier comprising a solid material active in lowering the viscosity of the polymeric liquid, the solid material at a concentration of less than about 2% by weight of the composition and with particle sizes less than about 75 microns equivalent spherical diameter.

29. The method of claim 28 wherein the solid material lowers the viscosity of the polymeric liquid at stress amplitudes and strain rates where a linear relation exists between stress amplitude and strain rate.

30. The method of claim 28 wherein the solid material lowers the viscosity of the polymeric liquid at stress amplitudes and strain rates approaching and exceeding the critical stress value of the polymeric liquid.

31. The method of claim 28 wherein the solid material comprises a preparation of aluminosilicate.

32. The method of claim 28 wherein the preparation has a glass content of at least about 85% by weight.

33. A method of altering the performance of an additive in a polymer, the method comprising mixing the additive and a polymeric liquid in the presence of a viscosity modifier to form a composition, the viscosity modifier comprising a solid material active in lowering the viscosity of the polymeric liquid, the solid material at a concentration of less than about 2% by weight of the composition and with particle sizes less than about 75 microns equivalent spherical diameter.

34. The method of claim 33 wherein the solid material lowers the viscosity of the polymeric liquid at stress amplitudes and strain rates where a linear relation exists between stress amplitude and strain rate.

35. The method of claim 33 wherein the solid material lowers the viscosity of the polymeric liquid at stress amplitudes and strain rates approaching and exceeding the critical stress value of the polymeric liquid.

36. The method of claim 33 wherein the polymeric liquid comprises at least one recycled polymer.

37. The method of claim 33 wherein the solid material comprises a preparation of aluminosilicate.

38. A method of identifying a solid material for use in polymer processing, the method comprising:
(a) providing a composition of a polymeric liquid and a solid material,
(b) measuring the viscosity of the composition as a function of stress amplitude, strain rate and temperature; and
(c) determining whether the viscosity is lower for the composition compared to the polymeric liquid at stress amplitudes and strain rates where a linear relation exists between stress amplitude and strain rate.

39. The method of claim 38 further comprising the steps of measuring and evaluating the effect of a solid material characteristic on the viscosity of the composition, the solid material characteristic selected from the group consisting of particle size, particle shape, weight percent concentration of the solid material, structure of the solid material, and chemical composition of the solid material.

40. The method of claim 38 wherein the solid material has a concentration of less than about 2% by weight of the composition and particle sizes less than about 75 microns equivalent spherical diameter.

41. The method of claim 38 wherein the solid material comprises a preparation of aluminosilicate.

42. A method of influencing polymer processing efficiency, comprising:
(a) preparing a composition comprising a polymeric liquid and a solid material identified by the method of claim 38; and
(b) processing the composition in accordance with the composition's lower viscosity.

43. The method of claim 42 further comprising selectively altering at least one solid material characteristic at stress amplitudes and strain rates where a linear relation exists between stress amplitude and strain rate.

44. A method of influencing the physical and mechanical properties of a polymer, comprising:
(a) preparing a composition comprising a polymeric liquid and a solid material identified by the method of claim 38; and
(b) processing the composition in accordance with the composition's lower viscosity such that the physical and mechanical properties of the polymer are altered.

45. The method of claim 44 wherein the processing occurs at a temperature lower than the processing temperature of the polymeric liquid without solid material.

46. The method of claim 44 further comprising selectively altering at least one solid material characteristic at stress amplitudes and strain rates where a linear relation exists between stress amplitude and strain rate.

47. A method of purging polymer processing equipment, comprising processing a composition comprising a polymeric liquid and a solid material identified by the method of claim 38.

48. The method of claim 47 further comprising selectively altering at least one solid material characteristic at stress amplitudes and strain rates where a linear relation exists between stress amplitude and strain rate.

49. A method of identifying a solid material for use in polymer processing, the method comprising:
(a) providing a composition of a polymeric liquid and a solid material,
(b) measuring the viscosity of the composition as a function of stress amplitude, strain rate and temperature; and
(c) determining whether the viscosity is lower for the composition compared to the polymeric liquid at stress amplitudes and strain rates approaching and exceeding the critical stress value of the polymeric liquid.

50. The method of claim 49 further comprising the steps of measuring and evaluating the effect of a solid material characteristic on the viscosity of the composition, the solid material characteristic selected from the group consisting of particle size, particle shape, weight percent concentration of the solid material, structure of the solid material, and chemical composition of the solid material.

51. The method of claim 49 wherein the solid material has a concentration of less than about 2% by weight of the composition and particle sizes less than about 75 microns equivalent spherical diameter.

52. The method of claim 49 wherein the solid material comprises a preparation of aluminosilicate.

53. A method of influencing polymer processing efficiency, comprising:
(a) preparing a composition comprising a polymeric liquid and a solid material identified by the method of claim 49; and
(b) processing the composition in accordance with the composition's lower viscosity.

54. The method of claim 53 further comprising selectively altering at least one solid material characteristic at stress amplitudes and strain rates approaching and exceeding the critical stress value of the polymeric liquid.

55. A method of influencing the physical and mechanical properties of a polymer, comprising:
(a) preparing a composition comprising a polymeric liquid and a solid material identified by the method of claim 49; and
(b) processing the composition in accordance with the composition's lower viscosity such that the physical and mechanical properties of the polymer are altered.

56. The method of claim 55 wherein the processing occurs at a temperature lower than the processing temperature of the polymeric liquid without solid material.

57. The method of claim 55 further comprising selectively altering at least one solid material characteristic at stress amplitudes and strain rates approaching and exceeding the critical stress value of the polymeric liquid.

58. A method of purging polymer processing equipment, comprising processing a composition comprising a polymeric liquid and a solid material identified by the method of claim 49.

59. The method of claim 58 further comprising selectively altering at least one solid material characteristic at stress amplitudes and strain rates approaching and exceeding the critical stress value of the polymeric liquid.

60. A method of selecting a polymer-solid material composition for use in industrial scale polymer processing, the method comprising:
(a) selecting a solid material capable of lowering the viscosity of a polymeric liquid of a pre-selected polymer;
(b) determining a polymer-solid material formulation that provides for altered polymeric liquid viscosity;
(c) mixing the solid material and the polymer in accordance with the formulation determined in step (b), providing a polymer-solid material preparation;
(d) screening the polymer-solid material preparation for the absence of adverse polymer-solid material interactions; and
(e) evaluating the viscoelastic properties of the polymer-solid material preparation.

61. The method of claim 60, further comprising, between steps (a) and (b), the steps of coarse milling the solid material, beneficiating the coarse milled solid material, and final milling the beneficiated solid material.

62. The method of claim 60 further comprising the step of drying the beneficiated solid material after final milling.

63. The method of claim 60, further comprising, between steps (a) and (b), the step of classifying particle sizes of the solid.

64. The method of claim 60, further comprising, after step (e), determining the optimal processing conditions for industrial scale processing of the polymer-solid material preparation.

65. The method of claim 60, further comprising, after step (e), selectively altering at least one solid material characteristic in a manner sufficient to achieve at least one of the objectives of improving processing efficiency of the polymeric liquid, improving performance of additives, improving physical/mechanical properties of a finished polymer, and purging of contaminants from processing equipment.
